(19) United States
(12) Patent Application Publication
(10) Pub. No.: US 2010/0215939 A1
(43) Pub. Date: Aug. 26, 2010

(54) PRODUCTION AND USE OF LAMINATED NANOFIBROUS STRUCTURES

(76) Inventors: Philippe Westbroek, Dendermonde (BE); Tamara Van Camp, Gent (BE); Sander De Vrieze, Eine (Oudenaarde) (BE); Karen De Clerck, Sint-Amandsberg (BE)

Correspondence Address: BACON & THOMAS, PLLC, 625 SLATERS LANE, FOURTH FLOOR, ALEXANDRIA, VA, 22314-1176, US

(21) Appl. No.: 12/600,529

(22) PCT Filed: May 16, 2008
(86) PCT No.: PCT/EP08/56050

§ 371 Date: Mar. 11, 2010

(30) Foreign Application Priority Data
May 18, 2007 (EP) 07009995.7
Dec. 7, 2007 (EP) 07076056.6
Mar. 10, 2008 (EP) PCT/EP2008/052835

(51) Int. Cl. B32B 5/02; B29C 47/08; A61C 17/00

(52) U.S. Cl. 428/292.1; 425/174.8 E; 264/465; 433/216

(57) ABSTRACT

An electrospinning device is described for producing fibrous porous structures. The device is adapted for providing a predetermined distance profile for the distance between outlets of the electrospinning device and the receiving surface. The latter may be obtained by geometrically adapting the electrospinning device or by moving the outlets with respect to the receiving surface during growth of the fibrous structure. A fibrous structure obtained by the described electrospinning device is also described which comprises fibres, wherein the diameter of the fibres has a predetermined profile along a dimension of the electrospun fibrous structure. Furthermore application of the laminated structure for wound dressing and teeth bleaching is discussed.

### TECHNICAL FIELD OF THE INVENTION

The present invention relates to a fibrous structure, a process and a device for manufacturing the same. In particular, the present invention relates to methods and systems for electrospinning of fibrous structures and resulting products such as e.g. nanofibrous structures and their use. The present invention also relates to the field of wound dressing. More particularly, the present invention relates to methods and systems for controlling an amount of liquid near a surface, such as for example in wound dressing applications. The present invention also relates to the field of dental applications. More particularly, the present application relates to methods, products and systems for whitening of teeth applications.

### BACKGROUND OF THE INVENTION

Nanofibrous structures are useful in a variety of applications in the fields of clothing, filtering, medicine and defence. There is a strong interest in nanofibrous structures based on their high porosity for absorption, immobilization and inclusion of chemicals, solvent, solutions, melts and liquid phases. In many applications where high absorption is preferred, an absorption capacity of about 5 mL.cm⁻² is preferably obtained. In the same applications large nanofibrous structures are preferred. In order to guarantee homogeneous absorption behaviour over the structure it is useful to obtain a regular thickness over the entire structure. In addition, application of nanofibrous structures in filtration requires a strong structure with high dirt holding capacity, multilevel filtration, low cut-off value and limited pressure drop. Nanofibrous structures can be produced using an electrospinning setup. A basic setup is shown in FIG. 1 and consists of a high voltage source 1, an anaesthesia pump 2, the pump comprising a syringe 3 that contains a polymer solution 4 and the pump transporting polymer solution towards the tip of a metallic needle 5, said needle positioned in a spinneret 6, said spinneret comprising an upper 7 and a lower 8 conductive plate. An electrical field is applied over the upper and lower plate resulting in an extrusion ability of the polymer solution at the tip of the needle towards the surface of the lower element. The electrical field created, causes the polymer solution to overcome the cohesive forces that hold the polymer solution together. As a result of cohesive force compensation by the electrical field a jet will be drawn from the polymer solution droplet, which forms nano-dimensioned fibres, finally collected at the lower plate. Typical dimensions of the deposited structures are circular surfaces with a diameter of about 10 to 15 cm. Therefore, with a single nozzle system, it is not possible to obtain the large surface areas required for many applications in an economic feasible way.

In US2002/0175449 an apparatus and method for electrospinning polymeric fibres and membranes is disclosed. The method involves controlling the electrical field strength at the spinneret tip by adjusting the electric charge on a field modifying electrode to provide a fibre of controlled diameter. By changing the electrostatic potential, the jet stream acceleration is altered, resulting in varying the diameter of the formed nanofibre. This electrostatic potential variation changes the jet stream stability, and therefore, corresponding changes in the composite electrode can be used to stabilize the new jet stream. The distance between two neighbouring spinnerets may be varied to optimize the electrical field, i.e. such that the electric fields for the individual spinnerets do not influence each other.

One particular application of nanofibrous structures are wound dressing devices. Wound dressing can be applied for a plurality of wound types, such as for example for incisions, lacerations, abrasions, puncture wounds, penetration wounds, bum wounds.

Synthetic wound dressing originally was done using gauze-based dressing or paste bandages such as for example zinc paste bandages. Modern wound dressing devices often comprise important properties such as for example having a moisture keeping and absorbing function or having a moisture keeping and antibacterial function. Especially in the case of burn wounds, it is a major issue to deal with wound exudates produced by the wound. Techniques often used for treatment of such wounds are keeping the wounds as dry as possible, as this may assist in reduction of infection and assists in a better healing process. However, a survey revealed that for specific wounds it would be more advantageously to keep the wound exudates in the neighbourhood of the wound. The reason is that it is discovered that important molecules and co-factors involved in the wound healing process are present in the exudates.

Several wound dressing devices are public and commercially available. A particular category of wound dressing devices is based on the use of electrostatically spun material. U.S. Pat. No. 4,878,908 discloses an example of a wound dressing device having a woven textile backing, an adhesive surface at the edges and a pad of absorbent material covered by a mat of electrostatically spun material. Nevertheless, there is still room for improvement of wound dressing devices.

In one aspect the present invention relates to the field of teeth bleaching. For bleaching of teeth, two major categories of aesthetic applications are known being applications performed at the dental practice and applications which can be performed outside the dental practice, for example at the consumer's home or at any suitable place. Some of these solutions require a plurality of visits to the dental practice.

Some solutions involving applications which can be performed outside the dental practice, relate to the use of tray made to fit the mouth and teeth of the user, which is made at the dental practice but which can be used at home. Such a device typically may need to be re-used in view of the cost and must be robust in order to allow repeatedly handling, cleaning, filling, installation, removal, etc.

Low cost solutions also have been provided, wherein a one-size-fits-all system is used. As these systems often do not result in a perfect fit to the teeth, the amount of bleaching agent provided often is increased. On the other hand, such systems also suffer from leakage of the bleaching agent to the Gingiva and optionally to ingestion.

US2005/0196352 A1 by the Proctor and Gamble Company discloses a teeth bleaching method whereby the method includes applying a tooth bleaching delivery system to a plurality of adjacent teeth. The tooth bleaching delivery system includes a strip of material and a tooth bleaching composition having a peroxide active component. The method includes applying a first portion of the strip material to the facial surfaces of the teeth, folding a second portion of the strip of the material about the incisal edges of the plurality of adjacent teeth and folding a second portion of the strip material over incisal edges of the adjacent teeth to apply the second portion to the lingual surfaces of the teeth.

### SUMMARY OF THE INVENTION

It is an object of the present invention to provide innovative devices or methods for producing fibrous (e.g. nanofibrous) structures. It is an advantage of embodiments according to the present invention that fibrous structures comprising fibres, wherein the diameter of the fibres varies, e.g. decreases, along a dimension of the electrospun fibrous structure can be obtained and methods and apparatus for producing them. It is an advantage of embodiments according to the present invention that methods and systems are provided resulting in nanofibrous structures with a firm structure, i.e. nanofibrous structures that are little or not subject to decomposition, distortion or delamination in normal use. It is an advantage of embodiments according to the present invention that methods and systems are provided resulting in strong, porous and/or reproducible nanofibrous structures. It is furthermore an advantage of embodiments according to the present invention that fibrous structures with good liquid uptake are provided and methods for producing them. It is also an advantage of embodiments according to the present invention that fibrous structures with good control release and filtration properties are provided and methods for producing them. It is an advantage of embodiments according to the present invention that fibrous structures can be provided in an economic viable way. It is an advantage of embodiments according to the present invention that fibrous structures with a combination of two or more of the above described advantages can be obtained. It is an advantage of embodiments according to the present invention that laminated structures can be made. It is an advantage of embodiments according to the present invention that a good overlap is obtained using movement of the different nozzles with respect to the collector.

The above objective is accomplished by a method and device according to the present invention.

The invention relates to an electrospinning device for producing fibrous structures, said electrospinning device comprising a set of outlets for outputting solution or melt, a receiving surface for receiving output from said set of outlets, wherein said receiving surface is adapted to move in a first direction parallel to said receiving surface, said movement being responsible for the lengthwise production of said fibrous structure, a voltage source for generating a potential difference between said set of outlets and said receiving surface, characterized in that said electrospinning device is adapted so that during electrospinning a variation in the distance between outlets of the device and the receiving surface according to a predetermined profile is present during production of said fibrous structures, in order to obtain a predetermined fibre thickness profile over the fibrous structure. Such a variation according to a predetermined profile may be obtained by a predetermined distance profile for the distance between outlets and the receiving surface in a direction perpendicular to the receiving surface for different outlets along said first direction. The predetermined distance profile may be an increasing distance profile or a decreasing distance profile. The predetermined distance profile may be a monotonously increasing distance profile or a monotonously decreasing distance profile. It is an advantage of embodiments according to the present invention that devices are provided allowing to produce fibrous structures comprising fibres, wherein the diameter of said fibres decreases along a dimension of said electrospun fibrous structure and wherein the local variance of the fibres diameter in any section perpendicular to said dimension, is below a predetermined level, e.g. below 10%. In embodiments of the present invention, the diameter of said fibres decreases monotonously along a dimension of said electrospun fibrous structure. In other embodiments of the present invention, the diameter of the fibres is according to a predetermined fibre diameter profile along a dimension of the electrospun fibrous structure. For example, the diameter of said fibres decreases monotonously and continuously along a dimension of said electrospun fibrous structure.

In embodiments of the present invention, the set of outlets comprises subsets of outlets and each of said subset of outlets consists of outlets equidistant to said receiving surface and the distance between each subset and the receiving surface varies according to a predetermined distance profile along the direction of lengthwise growth of the fibrous structure. It is an advantage of embodiments of the present invention that layered structures comprising two or more adjacent layers can be produced, wherein each layer having two neighbouring layers is composed of fibres having an average diameter smaller than the average diameter of the fibres of one of its neighbouring layer and larger than the average diameter of the fibres of its other neighbouring layer.

In embodiments of the present invention, the set of outlets may be comprised in a plane inclined at an angle relatively to the receiving surface. This is advantageous as it permits the production of fibrous structure comprising fibres wherein the diameter of said fibres continuously decreases along a dimension of the fibrous structure.

According to embodiments of the present invention, the distance of the nozzles to the collector variation is present during the electrospinning process, optionally in combination with a distance variation before and/or after the process.

In embodiments of the present invention, at least two neighbouring outlets of said set of outlets may be separated from one another by a distance of at least 1 cm. It is an advantage of embodiments according to the present invention that devices are provided allowing production of fibrous structures with high porosity. At least two neighbouring outlets of said set of outlets may be separated by a distance of at least 1 cm. It is particularly advantageous to separate two neighbouring outlets by a distance of at least 4 cm and very advantageous to separate two neighbouring outlets by a distance of at least 8 cm. Each two outlets of said set of outlets may be separated from one another by a distance of at least 1 cm, advantageously a distance of at least 4 cm and more advantageously of at least 6 cm. In other words, there is at least one outlet (e.g. a nozzle) for which the distance to the closest other outlet is at least 1 cm, advantageously at least 4 cm and more advantageously at least 6 cm. A majority or all of said outlets may be separated from the other outlets by a distance of at least 1 cm, advantageously at least 4 cm and more advantageously at least 6 cm. It is an advantage of embodiments according to the present invention that devices are provided allowing production of fibrous structures that are strong, have high porosity and straight fibres. As an optional feature, the outlets (e.g. needles) are positioned in a triangle setup or a multiple thereof.

In embodiments of the present invention, the distance between the outlets may be adapted for obtaining a fibrous structure comprising at least 50% of fibres substantially free of cross-links to neighbouring fibres. It is an advantage of embodiments according to the present invention that devices are provided allowing production of fibrous structures wherein only a low degree of cross-linked fibres is present.

In embodiments of the present invention, the distance between the outlets may be adapted for obtaining a fibrous structure comprising at least 50% of straight fibres.

The device may comprise control means for varying the diameter of the produced fibres substantially during the electrospinning process.

In embodiments of the present invention, the means for varying the diameter of the produced fibres may be control means for altering the distance between said first plane and said receiving surface during or outside the production of the fibrous structure. As an optional feature, the lower and the upper section are adapted to be moveable perpendicularly to each other.

In embodiments of the present invention, the device may be adapted for generating a plurality of fibres, whereby at least 50% of said plurality of fibres may comprise an average diameter between 3 and 2000 nm.

In embodiments of the present invention, the device may be adapted for using a polymer solution or melt comprising at least one of a polyamide, polystyrene, polycaprolactone, polyacrylonitrile, polyethylene oxide, polylactic acid, polyacrylic acid, polyesteramide, polyvinyl alcohol, polyimide, polyurethane, polyvinylpyrrolidon, polyethylene co vinyl acetates and alcohols, collagen, cellulose, chitosan, methacrylates, silk or metal.

The present invention also relates to a method for producing fibrous structures, said method comprising the steps of providing a set of outlets for outputting solution or melt, providing a receiving surface for receiving output from said set of outlets, moving said receiving surface in a first direction parallel to said receiving surface, applying a potential difference between said set of outlets and said receiving surface, and, during said moving and applying, providing a solution or melt to said outlets, wherein a variation in the distance between outlets and the receiving surface according to a predetermined profile is present during the providing of the solution or melt to the outlets, in order to obtain a predetermined fibre thickness profile. The presence of such a predetermined profile may be induced by a variation of the distance between outlets and the receiving surface in a direction perpendicular to the receiving surface for outlets along the direction of lengthwise growth of the fibrous structure or may be induced by an actual relative movement of the set of outlets relatively to the receiving surface. The predetermined distance profile may be an increasing or decreasing distance profile, e.g. a monotonous increasing or monotonous decreasing distance profile. At least two neighbouring outlets of said two or more outlets may be separated by a distance of at least 1 cm, advantageously at least 4 cm and more advantageously at least 6 cm. Each two of said set of outlets may be separated from one another by a distance of at least 1 cm, advantageously at least 4 cm and more advantageously at least 6 cm.

The variation of the distance between the outlets and the receiving surface may optionally be obtained by adapting the distance between said neighbouring outlets and said receiving surface during the production of the fibrous structure.

The distance may be adapted by providing a relative movement between said set of outlets and said receiving surface.

As an advantageous optional feature, the method may further comprise the step of moving reciprocally at least one of said set of outlets and/or said receiving surface in a direction parallel to said receiving surface and perpendicular to said first direction.

The method may be adapted for generating a plurality of fibres, whereby at least 50% of said plurality of fibres comprises an average diameter between 3 and 2000 nm.

The method may be adapted for using a polymer solution or melt comprising at least one of a polyimide, polystyrene, polycaprolactone, polyacrylonitrile, polyethylene oxide, polylactic acid, polyacrylic acid, polyesteramide, polyvinyl alcohol, polyimide, polyurethane, polyvinylpyrrolidon,polyethylene co vinyl acetates and alcohols, collagen, cellulose, chitosan, methacrylates, silk or metal.

As an optional feature, a voltage difference of between 100 V and 200000 V may be applied over the set of outlets and the receiving surface.

As another optional feature, the pump rate of the polymer solution or melt per outlet may be between 0.01 and 500 mL h⁻¹.

As an optional feature, the solutions or melts may contain an additional compound, such as compounds with antibacterial, pharmaceutical, hydrophobic/hydrophilic, anti corrosion, catalytic, oxidative/reductive and other properties.

The present invention also relates to an electrospun fibrous structure manufactured using a method according to embodiments of the present invention as described above.

The present invention also relates to an electrospun fibrous structure comprising fibres, wherein the diameter of said fibres varies according to a predetermined fibre diameter profile along a dimension of said electrospun fibrous structure and wherein the variance of the fibres diameter in any section perpendicular to said dimension, is below 10%.

In embodiments of the present invention, the structure comprises at least 50% of straight fibres, wherein at least 50% of straight fibres consists of 50% or more fibres having segments substantially straight over a distance of 5 μm.

The electrospun fibrous structure may comprise at least 50% of fibres that is substantially cross-link free with respect to neighbouring fibres.

The electrospun fibrous structure may comprise at least 50% of randomly oriented fibres.

The electrospun fibrous structure may have a porosity of at least 65%.

50% or more of its fibres may have an average diameter between 3 and 2000 nm, preferably equal or above 10 nm, preferably equal or below 700 nm.

The present invention also relates to an electrospun fibrous structure comprising two or more layers, wherein each of said layers is composed of fibres having an average diameter different from the average diameter of the fibres of an adjacent layer.

In embodiments of the present invention, the fibrous structure comprises two or more adjacent layers, wherein each layer having two neighbouring layers is composed of fibres having an average diameter of a predetermined size which may be larger or smaller than the average diameter of the fibres of its neighbouring layer. In some embodiments the average diameter of the fibres may be smaller than the average diameter of the fibres of one of its neighbouring layer and larger than the average diameter of the fibres of its other neighbouring layer. The diameter may for example decrease as function of the depth, increase as function of the depth, first decrease and then increase as function of the depth, first increase and then decrease as function of the depth, etc.

It is also an object of embodiments of the present invention to provide good apparatus or methods for controlling liquid, e.g. exudates, near wounds. It is an advantage of embodiments according to the present invention that the amount and flow of liquids can be controlled. It is an advantage of embodiments according to the present invention that a controlled, optionally large, amount of exudates can be absorbed. It is an advantage of embodiments according to the present invention that a good control of transfer of fluid from and/or to the wound via the contact surface of the wound dressing device can be obtained. Such transfer may be towards an area distinct from the wound or contact surface of the wound dressing. It is an advantage of embodiments according to the present invention that a controlled release of fluid can be obtained, e.g. at the side opposite to the contact surface of the wound dressing device. It is an advantage of embodiments that the wound fluid can be taken up but kept in the neighbourhood of the wound and even be released back to the wound when a specific structure of the embodiment is used. It is an advantage of embodiments according to the present invention that the wound dressing device allows controlling of the amount of exudates removed from the wound so that a controlled amount of exudates can be present near the wound.

The above objective is accomplished by a method and device according to embodiments of the present invention.

The present invention relates to a wound dressing device for controlling fluid near a wound, the wound dressing device comprising a nanofibrous structure comprising a plurality of fibres, wherein the nanofibrous structure comprises a contact surface for contacting the wound, and a diameter of the fibres of the nanofibrous structure varies in a direction perpendicular to the contact surface in order to control fluid uptake from and/or release to the wound. It is an advantage of embodiments according to the present invention that a controlled liquid uptake can be obtained. It is an advantage of embodiments according to the present invention that a large liquid uptake can be obtained. It is an advantage of the embodiment that a controlled amount of liquid can be taken up and that the liquid taken up can be released at the other side of the dressing or released back to the wound.

The wound dressing device may comprise, at an intermediate position in a direction perpendicular to the contact surface, fibres having a diameter smaller than the diameter of the fibres at the contact surface and smaller than the diameter of the fibres at the surface opposite to the contact surface. It is an advantage that a predetermined profile of liquid uptake and/or release from and to the wound can be obtained.

The diameter of the fibres may decrease from the contact surface to a surface of the nanofibrous structure opposite the contact surface. It is an advantage of embodiments according to the present invention that a dynamic transfer of fluid from the contact surface to the other surface may be established. It is an advantage of embodiments according to the present invention that the wound, which may be seen as a liquid releasing surface can be kept substantially dry. Alternatively or in addition thereto, a controlled amount of liquid can be kept at or near the wound, which may be advantageous for the healing process. It is an advantage of embodiments according to the present invention that the most efficient evaporation properties can be obtained at the surface opposite to the contact surface as the highest specific surface area is obtained there. The side opposite the contact surface therefore may function as liquid releasing side. Alternatively or in addition thereto, controlled release back towards the wound also may be obtained.

The diameter of the fibres may also follow another relationship such as decreasing from the contact surface, going to a minimum in the centre of the structure and increasing from that centre to the surface of the nanofibrous structure opposite the contact surface. Using such a structure allows to withdraw fluid from the wound but also to release fluid back to wound. This results in an equilibrium of fluid in the wound, a condition that has recently been described as being favourable for wound healing processes.

The nanofibrous structure may be a laminated nanofibrous structure comprising at least two layers of nanofibres having a different diameter.

The wound dressing device may comprise at least one intermediate layer of nanofibres, positioned between other layers of nanofibres of the wound dressing device, whereby the at least one intermediate layer may comprise nanofibres having a diameter smaller than the diameter of the nanofibres in the other layers.

The nanofibrous structure may be electrospun. It is an advantage of embodiments according to the present invention that the wound dressing device can be made in an efficient way.

The nanofibrous structure may have an average porosity between 65 and 99%, preferably between 70 and 98 and more preferably between 75 and 95%. It is an advantage of embodiments according to the present invention that a high absorption capacity can be obtained. The liquid absorption capacity may be between 1 g and 25 g per 1 g polymer, advantageously between 10 g and 25 g per 1 g polymer.

The nanofibrous structure furthermore may comprise a gel forming compound. It is an advantage of embodiments according to the present invention that the absorption capacity of the wound dressing device can even be increased to a liquid uptake of up to 70 g per 1 g of polymer.

The gel forming compound may be provided as coating onto the individual nanofibres. The gel forming compound may be provided in the wound dressing device by electrospinning it in the nanofibres.

The nanofibrous structure may comprise at least a portion wherein the pore diameter is smaller than 150 nm, in order to function as barrier for bacteria. It is an advantage of embodiments according to the present invention that a bacteria barrier can be obtained for wounds due to the size of pores in the nanofibrous structure being substantially smaller than the typical size of bacteria.

The nanofibrous layer may comprise liquid transport barriers in at least a portion of the nanofibrous layer at the side of the contact surface, the liquid transport barriers preventing lateral flow of liquid over the contact surface. With lateral flow there is meant flow in directions within the plane of the contact surface. It is an advantage of embodiments according to the present invention that cross-infection between neighbouring wounds can be reduced as the flow of liquid from one wound to another wound can be reduced, slowed down or even prevented. The liquid transport barriers may be adapted to distribute the contact surface of the nanofibrous structure in a plurality of small, individual, separated nanofibrous areas and for preventing flow of liquid near the contact surface between neighbouring areas. The liquid transport barriers may comprise melted nanofibres and/or nanofibres sticking together. The liquid transport barriers may extend only over part of the depth in the direction perpendicular to the contact surface. It is an advantage of embodiments according to the present invention that, first inhibition of flow of exudates to neighbouring wound areas can be obtained, secondly providing a partial spreading of the moisture at the side opposite to the contact surface can assist in efficient evaporation and third exudates can be kept in the nanofibrous structure for later release back into the wound, if required for the wound healing process.

The nanofibrous layer also may comprise liquid transport barriers for keeping the liquid in the nanofibrous structure for later release to the wound.

The nanofibrous structure furthermore may comprise nanofibres comprising disinfecting materials, said nanofibres being positioned in the wound dressing device near the contact surface. The nanofibres comprising disinfecting materials may be dissolvable upon liquid uptake by the nanofibrous structure inducing disinfecting and anti-microbial and/or biocide properties for the device. It is an advantage of embodiments according to the present invention that antibacterial and/or biocide properties may be present in the wound dressing device, without the need for using a separate product for inducing antibacterial and/or biocide properties.

The nanofibres comprising disinfecting material may comprise isobetadine® nanofibres. The isobetadine® fibres may be obtained by electrospinning a PVP-I solution.

The wound dressing device may be able to take up between 1 and 25 g of liquid per 1 g nanofibrous structure, for a liquid having a density of 1 kg/l.

The wound dressing device may have a liquid uptake capacity between 3 and 25 times its own weight, preferably between 4 and 25 times and more preferably between 5 and 25 times, for a liquid with a density of about 1 kg/l.

The device may be suitable for wound bum dressing or dressing for large wounds, the nanofibrous structure having a contacting surface of at least 30 cm by 30 cm, preferably 40 cm by 40 cm and more preferably 50 cm by 50 cm. Alternatively, the devices may be suitable for very small wounds and have a size below 2 cm by 2 cm, or even below 5 mm by 5 mm. The nanofibrous structure may have a thickness between 50 μm and 5000 μm.

The wound dressing device may be cuttable in any shape by hand or with a machine using mechanical, thermal or laser induced cutting.

The nanofibrous structure may be provided on a substrate comprising adhesive properties for sticking to skin around the wound.

At least 30%, advantageously at least 50% of the nanofibres of the nanofibrous structure may have an average diameter between 3 and 2000 nm.

The nanofibrous structure may comprise at least 50% of straight fibres wherein at least the fibres have segments substantially straight over a distance of 5 μm.

The nanofibrous structure may comprise at least 50% of randomly oriented fibres.

The present invention also relates to the use of a wound dressing device as described above for wound dressing.

The present invention furthermore relates to a method for wound dressing, the method comprising obtaining a nanofibrous structure having a contact surface for contacting the wound and wherein the diameter of the fibres varies in a direction perpendicular to the contact surface according to a predetermined profile, and positioning the nanofibrous structure by contacting the wound with said nanofibrous structure in a predetermined direction.

It is an advantage of embodiments according to the present invention that oxygen can be transported through the wound dressing device, i.e. through the nanofibrous structure. The latter assists in improvement of the wound healing.

It is also an object of the present invention to provide good methods and systems for whitening of teeth, also referred to as teeth bleaching. It is an advantage of embodiments according to the present invention that methods and systems allow accurate delivery of teeth bleaching moiety or components thereof. It is an advantage of embodiments according to the present invention that methods and systems are provided allowing little or no leakage to the area of the mouth surrounding the teeth. It is an advantage of embodiments according to the present invention that delivery of teeth bleaching moiety or components thereof can be provided to the canine teeth. It is an advantage of embodiments according to the present invention that a system is provided allowing stable positioning and/or fixation of the device on the teeth of a user. It is an advantage of embodiments according to the present invention that methods and systems are provided requiring less components or particular properties of the bleaching moiety for fixing the device to the teeth, e.g. avoiding the need for a fixating component in the teeth bleaching moiety. It is an advantage of embodiments according to the present invention that methods and systems are provided allowing the use of a low viscosity teeth bleaching, allowing more efficient whitening of teeth.

It is an advantage of embodiments according to the present invention that devices can be made providing a good fit while allowing to also cover the canine teeth. It is an advantage of embodiments according to the present invention that the teeth can be whitened in a relative smooth and/or uniform way. It is an advantage of embodiments according to the present invention that a row of front teeth, including the canine teeth, can be whitened in an accurate and substantially uniform way. It is an advantage of embodiments according to the present invention that the tips of the canine teeth also are covered and therefore also can be whitened. It is an advantage of embodiments according to the present invention that good transport of the teeth bleaching moiety through the device can be obtained. It thereby is an advantage of embodiments according to the present invention that a folding line in the fibrous structure can be avoided, while still a good fit can be obtained and the folded shape over the teeth can be maintained during use of the device. Inhibition of the transport of teeth bleaching moiety or components thereof due to the presence of the folding line thus can be avoided. It is an advantage of embodiments of the present invention that the fibrous structure in the device provides the possibility of a good fit of the structure.

It is an advantage of embodiments according to the present invention that the fibrous structure of the device may allow water permeability, thus assisting in the uptake of teeth whitening moiety.

It is an advantage of embodiments according to the present invention that the fibrous structure may have a variable fibre diameter as function of the depth in the fibrous structure so as to control a profile in the release of teeth bleaching moiety.

It is an advantage of embodiments according to the present invention that methods and systems are provided allowing

The above objective is accomplished by a method and device according to the present invention.

The present invention relates to a teeth whitening system for whitening teeth, the teeth whitening system comprising a nanofibrous structure and a teeth whitening moiety comprising a bleaching agent. It is an advantage of embodiments according to the present invention that methods and systems allow accurate delivery of teeth bleaching moiety or components thereof. It is an advantage of embodiments according to the present invention that methods and systems are provided allowing little or no leakage to the area of the mouth surrounding the teeth. It is an advantage of using a nanofibrous structure that the system can adapt and maintain a good fit to the teeth.

The teeth whitening moiety may have a viscosity between 10 cps and 1000 cps, advantageously between 10 cps and 400 cps, more advantageously between 10 cps and 199 cps. It is an advantage of embodiments according to the present invention that methods and systems can be provided wherein the teeth whitening moiety may have relatively low viscosity, due to the fluid taking-up and releasing properties of the nanofibrous structure. It is an advantage of embodiments according to the present invention that gels with low viscosity can be used for teeth whitening applications, whereby the gels can be kept in the system due to the nanofibrous structure. It is an advantage of embodiments according to the present invention that the risk of leaking out of the structure, e.g. on the Gingiva or the Palate in the mouth is limited, reduced or even avoided.

The teeth whitening moiety may be a teeth whitening gel, wherein the teeth whitening gel furthermore may comprise a gel forming material. It is an advantage of embodiments according to the present invention that the use of gel reduces or prevents occurrence of leakage. The latter may increase the comfort for the user. It may for example result in a reduction of irritation of parts of the mouth surrounding the teeth.

The concentration of gel forming material may be lower than 0.1 weight percent of the teeth whitening moiety, e.g. lower than 0.09 weight percent of the teeth whitening moiety.

The gel forming material may comprise carboxymethylcellulose, carboxypropylcellulose, gum, poloxamer, or carboxypolymethylene. It is an advantage of embodiments according to the present invention that low concentrations of gel forming materials may be used as the viscosity of the bleaching moiety may be lower due to the presence of the nanofibrous structure.

The nanofibrous structure of the system may be adapted for fitting to a row of front teeth. It is an advantage of embodiments according to the present invention that the nanofibrous structure is adapted so that it can be compressed to a set of teeth.

The nanofibrous structure of the system may be adapted for fitting to incisor teeth and canine teeth, including the tips of the canine teeth. The incisor teeth are the four front teeth at the top or the four front teeth at the bottom of the mouth. It is an advantage of embodiments according to the present invention that the canine teeth adjacent to the incisor teeth also can be bleached, as these canine teeth often have a more yellowish colour and as bleaching also the canine teeth will result in a more homogeneous colour for canine and incisor teeth so that no large contrast between the canine teeth and the incisor teeth is obtained.

The nanofibrous structure may be compressible to a thickness between 100 nm and 10 mm. It is an advantage of embodiments according to the present invention that a fitting over the incisor teeth as well as over the canine teeth can be made by using a compressible nanofibrous structure that can fit to the teeth. It is an advantage of embodiments according to the present invention that the device, or at least the fibrous structure thereof, can be pressed to the teeth so that by compressing the device, or at least the fibrous structure thereof, the device or at least the fibrous structure thereof adopts to the shape of the teeth.

The nanofibrous structure may have a thickness between 1 μm and 5000 μm, advantageously between 1 μm and 2000μm.

The structure of the nanofibrous structure may be adapted for inducing an adhesive effect of the system on the surface of teeth. It is an advantage of embodiments according to the present invention that no additional components or property requirements are to be posed on the teeth whitening moiety for having an adhesive effect on the teeth surface.

The nanofibrous structure may have an average porosity between 65 and 99%, preferably between 70 and 98 and more preferably between 75 and 95%. It is an advantage of embodiments according to the present invention that the porosity of the nanofibrous structure is adapted for inducing such adhesive effect.

The system may be adapted for being fixed at a front side of teeth using a first part and at a back side of the teeth using a second part.

The nanofibrous structure may have a variation in porosity over its cross section adapted for providing a controlled transport of the bleaching agent towards the teeth.

The nanofibrous structure may have a predetermined variation profile in porosity over its cross section adapted for obtaining a predetermined release profile of the bleaching agent towards the teeth. It is an advantage of embodiments according to the present invention that a controlled release of the bleaching agent can be provided, assisting in obtaining a homogeneous effect during the treatment.

The porosity of the nanofibrous structure may increase from the side contacting the substrate layer to the side that will contact the surface of the teeth.

The nanofibrous structure may be a laminated nanofibrous structure comprising at least two layers of nanofibres having a different diameter.

The teeth whitening system may comprise a substrate layer for supporting the nanofibrous structure, the substrate layer being substantially water impermeable and water insoluble. It is an advantage of embodiments according to the present invention that the substrate may provide a better fit of the system over the teeth. It is an advantage of embodiments according to the present invention that the substrate may provide a barrier for leakage of bleaching moiety e.g. to the gingival area and/or at the tongue.

The nanofibrous structure comprises fibres comprising a pH setting agent. It is an advantage of embodiments according to the present invention that at least part of the pH setting agent can be kept separate from the bleaching agent before use or before preparation of the system for use. The latter is advantageous as it allows to increase the efficiency of the bleaching agent during use or it allows to increase the product lifetime of the system. It furthermore is an advantage of embodiments of the present invention that the pH-setting agent can be comprised in the nanofibrous structure, avoiding the need for a further component to stored separately before use.

The teeth whitening moiety may comprise a pH setting agent.

The pH setting agent may comprise any or a combination of sodium hydroxide, hydrogen chloride, sodium phosphate, sodium bicarbonate, sodium stannate, citric acid or sodium citrate.

The pH setting agent in the moiety may be between 0.1 weight percent and 10 weigh percent.

The concentration of bleaching agent may be between 0.1 and 25 weight percent of the teeth whitening moiety, advantageously between 0.5 and 10 weight percent of the teeth whitening moiety, more advantageously between 1 and 7 weight percent of the teeth whitening moiety.

The bleaching agent may comprise any or a combination of peroxides or peroxide generating compounds. Peroxides may be for example hydrogen peroxide or calcium peroxide. Peroxide generating compounds may be percarbonates such as for example carbamide peroxide, perborates or peroxyacids. Bleaching materials that advantageously may be used are hydrogen peroxide or carbamide peroxide or a mixture thereof. It is an advantage of hydrogen peroxide that it has a high effectiveness.

The teeth whitening moiety furthermore may comprise a filling compound.

The filling compound may comprise one or more of glycerine, sorbitol, polyethylene glycol or propylene glycol.

At least 30%, preferably at least 50% of the nanofibres of the nanofibrous structure may have an average diameter between 3 and 2000 nm.

The nanofibrous structure may comprise at least 50% of straight fibres wherein the fibres have segments substantially straight over a distance of at least 5 μm.

The nanofibrous structure may comprise at least 50% of randomly oriented fibres.

The nanofibrous structure may be an electrospun nanofibrous structure.

Upon application of the system between 2 and 30 minutes onto the teeth with a frequency of twice a day during a period of between 5 and 14 days, a teeth whitening benefit of at least 1 and maximum 14 shades on the vitashade scale may be obtained. It is an advantage of embodiments according to the present invention that these provide in good whitening effects.

The teeth whitening system may be a kit adapted to keep the nanofibrous structure and the teeth bleaching moiety separate during storage before use.

The kit furthermore may comprise a tray for soaking the nanofibrous structure in the teeth bleaching moiety when initiating use of the teeth whitening system.

The nanofibrous structure may comprise fibres made of polyimide made by electrospinning using a mixture of formic acid and acetic acid. The ratio of formic acid and acetic acid may be between 90/10 and 10/90 weight percent, preferably between 30/70 and 70130 weight percent and more preferably between 40/60 and 60/40 weight percent. It may be a 50/50 weight percent ratio.

The present invention also relates to the use of a teeth whitening system as described above for teeth bleaching.

The present invention also relates to a nanofibrous structure, the nano-fibrous structure being adapted for use in a teeth whitening application.

The nanofibrous structure may be adapted for fitting to a row of front teeth.

The nanofibrous structure of the system may be adapted for fitting to incisor teeth and canine teeth, including the tips of the canine teeth.

The nanofibrous structure may be compressible to a thickness between 100 nm and 5 mm.

The nanofibrous structure may have a thickness between 1 μm and 5000 μm, advantageously between 1 μm and 2000μm.

The structure of the nanofibrous structure may be adapted for inducing an adhesive effect of the system on the surface of teeth.

The nanofibrous structure may have an average porosity between 65 and 99%, preferably between 70 and 98 and more preferably between 75 and 95%.

The system may be adapted for being fixed at a front side of teeth using a first part and at a back side of the teeth using a second part.

The nanofibrous structure may have a variation in porosity over its cross section adapted for providing a controlled transport of the bleaching agent towards the teeth.

The nanofibrous structure may have a predetermined variation profile in porosity over its cross section adapted for obtaining a predetermined release profile of the bleaching agent towards the teeth.

The porosity of the nanofibrous structure may increase from the side contacting the substrate layer to the side that will contact the surface of the teeth.

The nanofibrous structure may be a laminated nanofibrous structure comprising at least two layers of nanofibres having a different diameter.

The teeth whitening system may comprise a substrate layer for supporting the nanofibrous structure, the substrate layer being substantially water impermeable and water insoluble.

The nanofibrous structure may comprise fibres comprising a pH setting agent.

The pH setting agent may comprise any or a combination of sodium hydroxide, hydrogen chloride, sodium phosphate, sodium bicarbonate, sodium stannate, citric acid or sodium citrate.

The pH setting agent in the moiety may be between 0.1 weight percent and 10 weight percent of the moiety

The nanofibrous structure may comprise fibres made of polyamide made by electrospinning using a mixture of formic acid and acetic acid. The ratio of formic acid and acetic acid may be between 90/10 or 10190 weight percent, preferably between 30/70 and 70/30 weight percent and more preferably between 40/60 and 60/40 weight percent. It may be 50 weight percent to 50 weight percent.

The present invention also relates to the use of a nanofibrous structure as described above for teeth bleaching.

The present invention also relates to a method for whitening teeth, the method comprising soaking a nanofibrous structure in a teeth whitening moiety, applying the soaked nanofibrous structure to the teeth for a predetermined time and removing the nanofibrous structure thereafter. The teeth whitening moiety may be present in an initial container which may be sealed. The teeth whitening moiety may be packed together with the nanofibrous structure. They may be packed in the container in which the teeth whitening moiety is to be poured. Such a package may be sealed with a plastic or cardboard film. For soaking the nanofibrous structure, the nanofibrous structure may be positioned in the container with the nanofibrous structure facing the moiety.

The method furthermore may comprise providing initial contact between said pH regulating agent and said bleaching agent, during said soaking the nanofibrous structure.

The method furthermore may comprise before said soaking the nanofibrous structure, providing the teeth whitening moiety in a container adapted for soaking the nanofibrous structure therein.

The present invention also relates to a method for manufacturing a nanofibrous structure, the method comprising electrospinning nanofibrous using a mixture of formic acid and acetic acid. The ratio of formic acid and acetic acid may be between 90110 or 10/90 weight percent, preferably between 30/70 and 70/30 weight percent and more preferably between 40/60 and 60/40 weight percent. It may be 50 weight percent to 50 weight percent.

Particular and preferred aspects of the invention are set out in the accompanying independent and dependent claims. Features from the dependent claims may be combined with features of the independent claims and with features of other dependent claims as appropriate and not merely as explicitly set out in the claims.

Although there has been constant improvement, change and evolution of devices in this field, the present concepts are believed to represent substantial new and novel improvements, including departures from prior practices, resulting in the provision of more efficient, stable and reliable devices of this nature.

The teachings of the present invention permit the design of improved methods and apparatus for manufacturing fibrous structures with enhanced properties.

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

### BRIEF DESCRIPTION OF THE DRAWINGS

FIG. 1 is a schematic representation of a side view of an electrospinning setup according to the prior art.

FIG. 2 is a schematic representation of a perspective view of an electrospinning device according to an embodiment of the present invention.

FIG. 3 is a schematic representation of a perspective view of an electrospinning device according to another embodiment of the present invention.

FIG. 4 is a schematic representation of a perspective view of an electrospinning device according to another embodiment of the present invention.

FIG. 5 is a schematic representation of a planar view of the positioning of the outlets for use in an electrospinning device according to embodiments of the present invention.

FIG. 6 is a schematic representation of a planar view of the positioning of the outlets for use in an electrospinning device according to other embodiments of the present invention.

FIG. 7 shows an example of a laminated nanofibrous structures obtainable using methods and systems according to embodiments of the present invention.

FIG. 8 shows an example nanofibrous structure having a layered structure comprising one layer with an average diameter of 500 nm, as can be obtained using a method according to an embodiment of the present invention.

FIG. 9 illustrates another layer of the example nanofibrous structure of FIG. 8 having an average diameter of 300 nm.

FIG. 10 shows the relationship between the nanofibre diameter and the distance between outlets and the receiving surface for the example of FIG. 8, as can be used in an embodiment of the present invention.

FIG. 11 illustrates an example nanofibrous structure having a layered structure comprising at one side fibres with an average diameter of 285 nm, as can be obtained using a method according to an embodiment of the present invention.

FIG. 12 illustrates the other side of the example nanofibrous structure of FIG. 8 having an average diameter of 180 nm.

FIG. 13 shows a profile of the distance between outlets and the receiving surface on the one hand and the average nanofibre diameter for different concentrations, as can be used according to an embodiment of the present invention.

FIG. 14 and FIG. 16 illustrate a fibrous structure with sub-layers prepared in distinct electrospinning processes whereby a delaminated structure is obtained after a mechanical force has been applied, whereas FIG. 15. Illustrates a fibrous structure prepared according to an embodiment of the present invention after a mechanical force has been applied indicating no delamination.

FIG. 17 is a schematic illustration of a setup for manufacturing a wound dressing device with a continuously variable fibre diameter in the z-direction according to an embodiment of the present invention.

FIG. 18 is a schematic illustration of a wound dressing device as obtainable using a setup as described in FIG. 17.

FIG. 19 is a schematic illustration of an alternative setup for manufacturing a wound dressing device with a laminated structure having a variable fibre diameter in the z-direction according to an embodiment of the present invention.

FIG. 20 is a schematic illustration of a wound dressing device as obtainable using a setup as described in FIG. 19.

FIG. 21 is a schematic illustration of a wound dressing device having fluid transfer barriers present throughout the full thickness of the nanofibrous structure for preventing fluid transfer in a lateral direction in the wound dressing device according to an embodiment of the present invention.

FIG. 22 is a schematic illustration of a wound dressing device having fluid transfer barriers for only part of the thickness of the nanofibrous structure for preventing fluid transfer in a lateral direction in the wound dressing device according to an embodiment of the present invention.

FIG. 23 is a schematic illustration of a wound dressing device having smaller fibre diameters at an intermediate position as obtainable using a setup as described in FIG. 17.

FIG. 24 is a schematic illustration of a laminated wound dressing device having smaller fibre diameters at an intermediate position as obtainable using a setup as described in FIG. 19.

FIG. 25 shows an example of a diagrammatic representation of a nanofibrous structure which may be used in a teeth whitening system according to an embodiment of the present invention.

### DESCRIPTION OF ILLUSTRATIVE EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not correspond to actual reductions to practice of the invention.

Furthermore, the terms first, second, third and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practised without these specific details. In other instances, well-known methods, structures and techniques have not been shown in detail in order not to obscure an understanding of this description.

The following terms are provided solely to aid in the understanding of the invention.

Unless provided otherwise, the terms “increasing” when applied to a parameter shall be understood as describing an evolution of this parameter toward higher values, said evolution optionally comprising plateaux wherein said parameter has a constant value.

Unless provided otherwise, the terms “decreasing” when applied to a parameter shall be understood as describing an evolution of this parameter toward lower values, said evolution optionally comprising plateaux wherein said parameter has a constant value.

Unless provided otherwise, the terms “continuously or monotonously increasing” when applied to a parameter shall be understood as describing an evolution of this parameter toward higher values, said evolution not comprising plateaux wherein said parameter has a constant value.

Unless provided otherwise, the terms “continuously or monotonously decreasing” when applied to a parameter shall be understood as describing an evolution of this parameter toward lower values, said evolution not comprising plateaux wherein said parameter has a constant value.

The invention will now be described by a detailed description of several embodiments of the invention. It is clear that other embodiments of the invention can be configured according to the knowledge of persons skilled in the art without departing from the technical teaching of the invention, the invention being limited only by the terms of the appended claims.

In a first aspect, the present invention relates to an electrospinning device for producing fibrous structures such as e.g. nanofibrous structures. In an embodiment of the first aspect, the electrospinning device comprises a set of outlets for outputting solution or melt. The electrospinning device of the present invention is a multi-nozzle device, i.e. a device comprising two or more outlets for outputting solution or melt, e.g. three or more outlets. The outlets are adapted for outputting material, e.g. solution or melt material to be used for the production of the fibres. For instance, the outlets may be nozzles, needles such as e.g. metallic needles, small holes or the likes. In embodiments of the present invention, the two or more outlets, e.g. three or more outlets, are separated from one another by a distance of at least 1 cm, e.g. of at least 4 cm. For instance, the outlets may be separated by a distance of 1 to 100 cm. By separating the outlets by 1 or more cm, advantageously by 4 or more cm, the fibrous structures obtained are usually stronger, more porous and comprise straighter fibres than for smaller spacing. The relatively large distance between the outlets (e.g. needles) allows a good evaporation of the solvent, thus resulting in high porosity of the fibrous structure obtained. Without being bound by theory this effect may result from a more complete fibre formation process at the moment of collection of those fibres. Advantageously, the distance between the two or more outlets is at least 4 cm, more advantageously 6 cm or more, still more advantageously at least 8 cm. The maximum spacing is arbitrary and will for instance depend on the porosity one wishes to achieve.

For a significant spacing between the outlets, the fibres constituting the fibrous structure may acquire a straightness over distances of 5 μm or more, 10 μm or more or even 20 μm or more. In parallel or in addition to this straightness, a majority of the fibres (i.e. 50% or more) constituting the fibrous structure tends to become cross-link free, i.e. not cross-linked to neighbouring fibres. The majority of the fibres is e.g. substantially cross-link free with respect to neighbouring fibres at their contact points. According to embodiments of the present invention, fibrous structures are obtained that comprise fibres that are cross-link free and thus not linked to each other, i.e. wherein the majority of the fibres, e.g. at least 50%, advantageously at least 70%, more advantageously at least 90%, even more advantageously 95% remains independent. Cross link free thereby may be less than 1 cross link per 1 mm fibre length, advantageously less than 1 cross link per 5 mm fibre length, more advantageously less than 1 cross link per 1 cm fibre length, still more advantageously less than 1 cross link per 5 cm fibre length, even more advantageously without cross links over the full length of the fibre. This effect is particularly pronounced for outlets separated by 4 cm or more. A cross-link thereby may be defined as a covalent bond linking one polymer chain of one fibre to another polymer chain of a neighbouring fibre. Weak physical interactions such as Van Der Waals interactions or hydrogen bridges are not covered by the definition of cross-links.

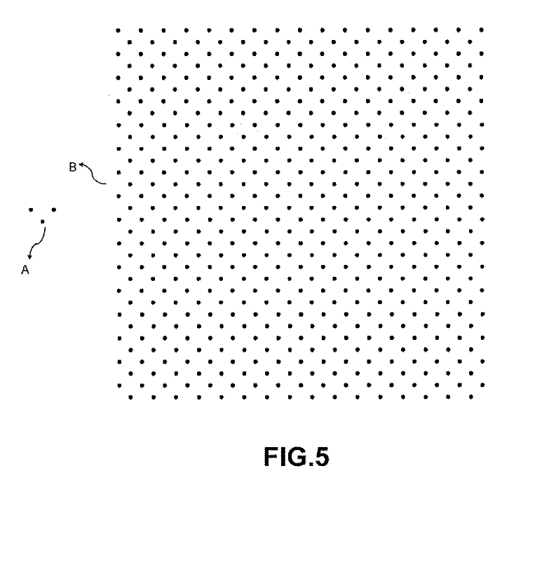

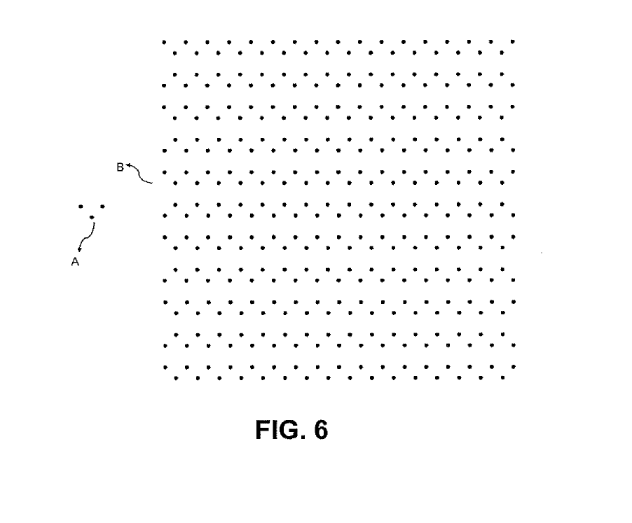

When three or more outlets are used, the outlets (e.g. needles) are advantageously arranged in sets of triangles (see FIG. 5) with a distance between each outlet of minimum 1 cm and maximum 100 cm, more advantageously of minimum 4 cm and maximum 100 cm and still more advantageously of minimum 6 cm and maximum 100 cm. In embodiments of the present invention where very volatile and/or easily ionizing solvents are used, the positioning of the needles may be adapted as shown in FIG. 6. In FIG. 6, the same individual positioning of the needles is respected as shown in FIG. 5 but for each two lines of needles, a third line is removed. In that case an individual needle is never surrounded by needles at all sides. This permits an easier evaporation of the solvent from the fibre formation area. The purpose a needle set-up as shown in FIG. 6 is to avoid favouring electrical discharges when using volatile or ionizing solvents. The total number of outlets is not limited to a maximal value. For instance, the total number of outlets used in a configuration may for example be between 3 and 20000, e.g. between 5 and 20000. Advantageously, the total number of outlets, e.g. needles, used in a configuration is between at least 3 and 500 (see FIG. 5). Different rows, such as e.g. neighbouring rows, of outlets may be parallel but shifted with respect to the corresponding position of the outlets with respect to each other. The latter may be evaluated with respect to the average direction of the relative movement of the receiving surface. The configuration of the outlets may be such that the outlets are positioned in triangular shaped groups of outlets. The different rows may for example result in a staggered configuration of outlets. The configuration may be such that for two neighbouring rows of outlets, a zigzag configuration of outlets is provided.

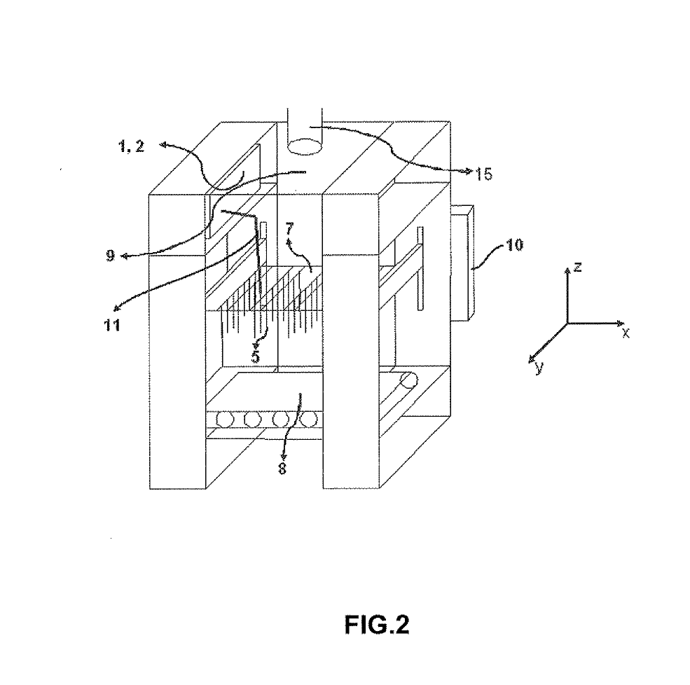

The electrospinning device according to the present invention comprises also a receiving surface. The receiving surface may optionally be coated with a perforated or non-perforated layer, e.g. a perforated or non-perforated polymer/plastic layer. The receiving surface may be a planar part of a larger surface not necessarily planar in all its parts. For instance, the receiving surface may be part of a larger belt comprising winded parts. The surface may contain a liquid surface on which the fibres are deposited. The receiving surface is adapted for receiving output from the set of two or more outlets, advantageously of three or more outlets. The receiving surface may be a metallic plate, a foil, a textile structure, a liquid surface, etc. The receiving surface may take any spatial orientation. For instance, it may be horizontal with the set of outlets above the receiving surface or with the receiving surface above the set of outlets. In those cases, the outlets would therefore be oriented downward or upward respectively. For instance the outlets (e.g. needles) are positioned in a lower plate and solution or melt (e.g. polymer solution or melt) jets move upwards the device. The receiving plate may also be oriented vertically. Other orientations for the receiving plate are of course possible (e.g. at 45° or any other angle with the horizon). The ensemble of, on one hand, the outlets and on another hand the receiving surface is also referred to as a spinneret. At least one of the receiving surface and the set of outlets is adapted to be moveable, i.e. one or more relative movements may be provided between the receiving surface and the set of outlets. The direction in which the set of outlets may be adapted to move in embodiments of the present invention, can be either parallel to the receiving surface or perpendicularly to the receiving surface. The movement of the outlets can also be a combination of a movement parallel to the receiving surface and perpendicular to the receiving surface. In embodiments of the present invention, the movement of the outlets is advantageously a reciprocal movement, e.g. a movement between two fixed points. This reciprocal movement is preferably parallel to the receiving surface and perpendicular to the direction of the movement responsible of the lengthwise growth of the fibrous structure. The movement of the receiving surface may be parallel to said receiving surface, orthogonal to said receiving surface or a combination of both. Advantageously, in embodiments of the present invention, the receiving surface can move continuously in one direction parallel to said receiving surface. Advantageously, the device is adapted for providing a relative movement to the set of outlets and the receiving surface, the relative movement being e.g. a combination of a relative movement in a first direction parallel to the receiving surface and in a second direction also parallel to the receiving surface but different from said first direction. For instance, the receiving surface can be adapted to undergo a relative movement at an angle to the first direction such as optionally substantially perpendicular to said first direction. Said first and second direction can be perpendicular to each other and parallel to said receiving surface. Advantageously, the set of outlets and the receiving surface can move relatively to each other so that the set of outlets moves in a first direction parallel to the receiving surface (e.g. the y-direction, see FIG. 2), e.g. reciprocally such as e.g. between two inversion points, and the receiving surface moves continuously in a second direction perpendicular to the first direction (e.g. the x-direction, see FIG. 2) but in the plane of said receiving surface. This type of reciprocal movement of the outlets is advantageous because it allows overlapping the output of the outlets as received on the receiving surface from the different outlets. The output of an outlet as received on the receiving surface may be referred to as the fibre umbrellas on the receiving surface. The fibre umbrellas have a high tendency to reject each other due to their charge and do not easily overlap if the configuration is used as a stationary system, i.e. if there is not at least a reciprocal relative movement between the receiving surface and the set of outlets. The amount of relative reciprocal movement may be selected such that the output of neighbouring outlets at least overlaps. Additionally, the width of the obtained fibrous structure can be increased in this way, i.e. by using a reciprocal movement. The set of outlets is advantageously subject to a relative reciprocal movement with respect to the receiving surface with an average speed between 0.1 cm s⁻¹ and 100 cm s⁻¹ in the direction of the lengthwise growth of the fibrous structure. Further relative movement, preferably a continuous relative movement in one direction parallel to the receiving surface, between the outlets and the receiving surface allows continuous production of larger fibrous structure surface areas, In this respect, the receiving surface is advantageously moveable with a speed between 10 cm h⁻¹ and 100 m h⁻¹.

The electrospinning device of the present invention further comprises a voltage source adapted to apply a potential difference between the outlets and the receiving surface. The voltage source may be a DC-high voltage source able to apply a potential difference selected in the range between 100 and 200000 V over the spinneret, i.e. between the outlets and the receiving surface. For instance, the outlets (e.g. needles) may be electrically in contact with each other through a conductive (e.g. metallic) plate or holding structure. In other embodiments, a semi or non-conductive first material plane (e.g. a plate) or holding structure can be used in combination with means such as e.g. a metallic wire for electrically connecting all the outlets (e.g. needles). The voltage source may be connected to an electro-conductive structure comprising the outlets or to means (e.g. wire) for electrically connecting all the outlets (e.g. needles). The receiving surface is advantageously grounded. Optionally it can be used ungrounded (floating) but adapted security measures are then preferably taken. Alternatively, the receiving surface can also be set at a certain potential using a second DC voltage source.

In an advantageous embodiment according to the present invention, the voltage source may be programmable or settable. The applied voltage may be adjusted or controlled as function of the outlet (tip) to collector (receiving surface) distance. The latter may be performed manually or automatically. Optimisation of the applied voltage may be performed so as to obtain a steady state operation.

Furthermore, the system may be adapted to receive information regarding polymer solution related parameters which may influence steady state operation of the system for obtaining fibres with a relatively fixed fibre diameter. The electrospinning system may for example be adapted for receiving, e.g. as data input or by measurement, information regarding any of, a combination of or all of the concentration of a polymer that will be used, the charge density, the solvent used or the viscosity.

The electrospinning device of embodiments of the present invention further may comprise at least one recipient for containing a solution or melt to be electrospun from said outlets. The recipient may contain a polymer solution or melt. Alternatively, the recipients may be external to the electrospinning device.

The electrospinning device of embodiments of the present invention advantageously further comprises means for providing the solution or melt to the outlets. The means for providing the solution or melt to the outlets can be any means known by the person skilled in the art. Examples of means for providing the solution or melt to the outlets comprise but are not limited to pumps or syringes among others as well as transfer means such as e.g. tubes.

For instance, each outlet (e.g. needle) can be fed with a solution or melt (e.g. a polymer solution or melt) by an individual means (such as e.g. an individual peristaltic pump). In some embodiments, a multichannel means (such as e.g. a multichannel peristaltic pump) can be used in which each channel feeds one individual outlet. Also a multiple of multichannel means (e.g. pumps) can be used, dependent on the amount of outlets that need to be fed with polymer solution or melt. In other embodiments, an anaesthesia type pump can be used to feed the outlets (e.g. needles) through syringes filled with polymer solution or melt and positioned in the anaesthesia pump. Alternatively, the outlets can be fed with solution or melt from a central tank kept at a predetermined, e.g. constant pressure with pressure valves and/or pressurized air. In some embodiments, a multiple amount of outlets (e.g. needles) can be fed by one source e.g. a peristaltic or anaesthesia pump. The injection rate (e.g. the pump rate) of solution, e.g. polymer solution, or melt per outlet (e.g. needle) may be between 0.01 and 500 mL h⁻¹.

Solutions or melts usable within the present invention are any solution or melt known by the person skilled in the art to be suitable for forming fibres by electrospinning. The solution or melt can be obtained from polymers. Suitable polymers comprise but are not limited to polyamides, polystyrenes, polycaprolactones, polyacrylonitriles, polyethylene oxides, polylactic acids, polyacrylic acids, polyesteramides, polyvinyl alcohols, polyimides, polyurethanes, polyvinylpyrrolidon, collagen, polyethylene co vinyl actetates and alcohols, cellulose and related products, chitosan, methacrylates, silk and combination thereof. The solution or melt may also contain metallic particles or metals dissolved as metallic ions so that metal containing fibres can be formed.

As an optional feature, the solutions or melts may contain an additional compound, such as compounds with antibacterial, pharmaceutical, hydrophobic/hydrophilic, anti corrosion, catalytic, oxidative/reductive and other properties.

The electrospinning device of the present invention may optionally further comprise a surrounding element, i.e. an element surrounding the other elements of the electrospinning device. For instance, the surrounding element can form a jacket around the spinneret and prevents the spinneret from instability such as air turbulence and/or allow solvent recuperation. Air turbulence are advantageously avoided in the spinneret because it may cause instability in the melt or solution jets and the fibre umbrellas produced by those jets on the receiving surface. The surrounding element may for instance be composed of plates of a non-conductive material connected to each other to form an enclosure.

The electrospinning device of the present invention may further comprise one or more optional temperature control means/systems. Those temperature control means may be added to the electrospinning device for instance in order to obtain higher reproducibility in fibre production. Fluctuations of temperature can have its influence on the evaporation rate of the solvent and thus on the final dimensions of the fibres and the porosity of the structures. Temperature controlling means are therefore advantageous. The solution or melt in the recipient may be temperature conditioned by using containers for (e.g. a liquid bath such as an oil or water bath) temperature control. The control of the temperature can also be operated during the solution transport from the recipient to the outlets via jacketed tubes that are connected directly or indirectly with a cooling/heating system such as said containers for temperature control. The spinneret may be temperature controlled by using means for bringing heated/cooled air in the spinneret. For instance, the electrospinning device of the present invention may comprise a temperature control system that allows controlling the temperature in the range 280-1500 K.

The electrospinning device according to embodiments of the present invention, may be adapted for operating in a steady state. The latter may be obtained by manually or automatically adjusting process parameters. Variation of process parameters for electrospinning in view of the variation of the nozzle outlet to collector distance, such as for example the voltage to be applied, humidity or flow rate may for example be determined experimentally. In principle it already provides a significant advantage to optimize the applied voltage when varying the distance between the nozzle outlets and the collector. Nevertheless, other parameters such as for example the flow rate of the starting materials also may be adjusted. The electrospinning device therefore may be adapted for varying such other process parameters such as for example flow rate of the materials to be electrospun and/or humidity. In order to adjust the flow rate of the materials to be electrospun, the electrospinning device may for example be equipped with a controllable pump for varying the speed of supplying materials to the outlets or it may be adapted with outlets having a settable and variable outlet opening. In order to adjust the humidity, the electrospinning system may be equipped with a system for controlling the humidity, such as for example a drying means and/or a humidifier. Adjustment of process parameters may be performed in agreement with predetermined rules, according to calculated models, based on trial and error experiments, or in any other suitable way. Optimisation may for example be performed by adjusting the parameters until a steady-state is reached. The steady state may be defined by the point where the Taylor cone is constant and spinning can be performed in a continuous way. Detection of such a steady state may be obtained optically, e.g. visually or using an optical detector, and adjusting of the parameters may be performed manually or in an automatic and/or automated way. The Taylor cone thereby is the shape of the distorted drop caused by a pending drop being present at the tip of the outlet and being shaped conically when a high voltage is applied.

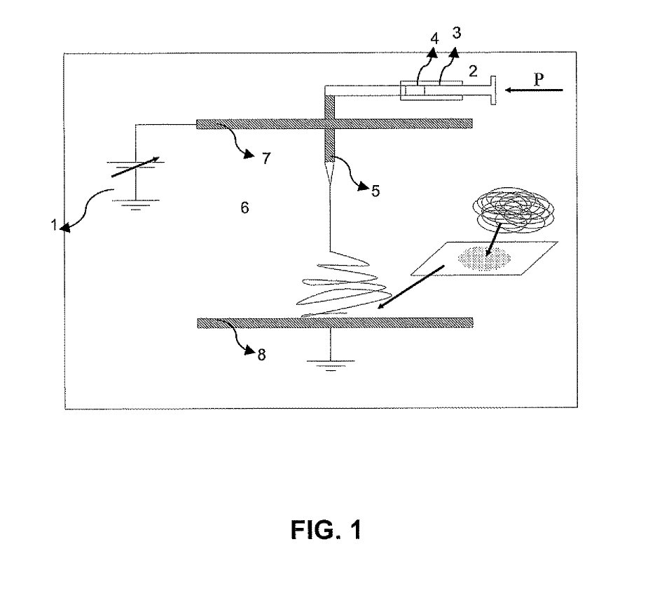

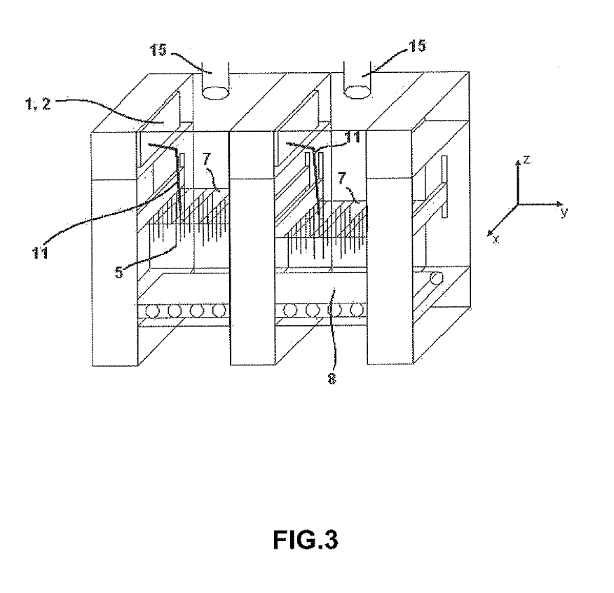

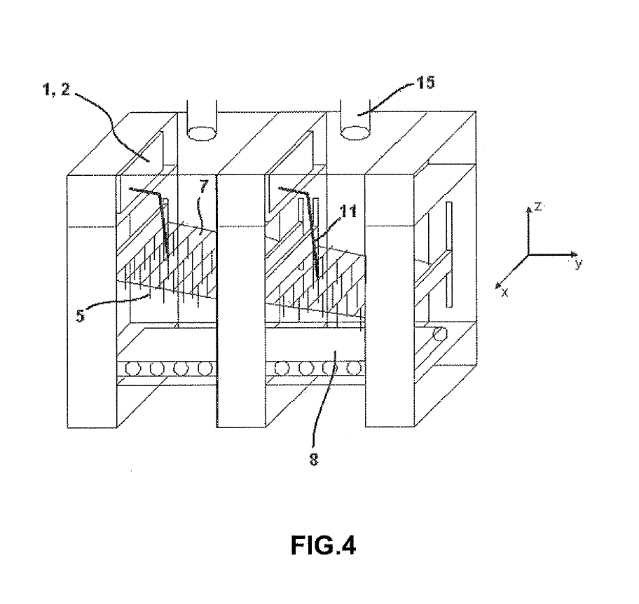

The electrospinning device of the present invention is adapted for providing a predetermined distance profile between the outlets (5, FIG. 1) and the receiving surface (8, FIG. 1) during production of the fibrous structure for inducing a predetermined fibre diameter profile along a dimension of the electrospun fibrous structure. The predetermined fibre diameter profile may be obtained in the thickness dimension of the electrospun fibrous structure. The latter allows obtaining an electrospun structure comprising fibres, wherein the diameter of the fibres in one direction of the electrospun fibrous structure has a predetermined profile. The latter may be advantageous as it provides to control certain properties of the electrospun fibrous structure in this direction. The predetermined distance profile may for example be obtained by providing a decreasing or increasing distance between the outlets (5) and the receiving surface (8) in a direction perpendicular to the receiving surface, for different outlets along said first direction, although the invention is not limited thereto. In one example, the predetermined distance profile may be obtained by providing a monotonously decreasing or increasing distance between the outlets (5) and the receiving surface (8). This feature permits to obtain an electrospun structure comprising fibres, wherein the diameter of said fibres decreases, e.g. monotonously decreasing, along a dimension of said electrospun fibrous structure. This can be realised in various not mutually excluded alternative ways as will be described here below. Providing a predetermined distance profile, e.g. (monotonously) decreasing or increasing distance, between the outlets (5) and the receiving surface (8) along the direction of lengthwise growth of the fibrous structure can be achieved by moving the set of outlets and the receiving surface relatively to one another at least with a component in a direction perpendicular to the receiving surface (see first embodiment below as will be shown with reference to FIG. 2), e.g. during electrospun operation, or by placing the outlets above the receiving surface according to an, optionally fixed, predetermined distance profile. The latter also results in a different distance to the receiving surface for a first set of outlets and for a second set of outlets. For example in a decreasing or increasing fibre thickness profile, the outlets may be positioned in such a way that the outlets further away in the direction of lengthwise grow of the fibrous structure are also closer to the receiving surface (as will be shown with reference to FIGS. 3 and 4). An obvious alternative is to place the outlets above the receiving surface in such a way that the outlets further away in the direction of lengthwise grow of the fibrous structure are also further away from the receiving surface. As will be shown this may be done by introducing a distance variation to the receiving surface for individual outlets as well as by introducing a distance variation between different sub-groups of outlets.

Alternatively, also the receiving surface can move to change the distance or positioned under a certain angle to obtain a predetermined distance profile, e.g. an increasing or decreasing outlet to receiving surface distance, e.g. monotonously.

A first embodiment to provide a predetermined distance profile, e.g. a decreasing or increasing distance, between the outlets and the receiving surface is to move vertically, and preferably continuously, the whole set of outlets relatively to the receiving surface (or to move vertically the receiving surface relatively to the set of outlets) during the fibre production. In this embodiment, it is necessary that the receiving surface carrying the growing fibrous structure is re-exposed during a longer period or repeatedly to the outlets in order to build the fibrous structure with varying fibre diameter in the thickness direction of the fibrous structure according to a predetermined profile. The fibrous structure is therefore only collected after a sufficiently long exposure or after that a sufficient number of re-expositions occurred. Re-exposition is easily achieved if an endless belt is used. Otherwise, a reciprocal movement of the receiving surface in the X direction may be used, in order to create large fibrous structures while coping with the limited size of the electro-spun system. If the vertical relative movement of the receiving surface and the set of outlets is discontinuous, a layered fibrous structure will be produced wherein each subsequent layer is composed of fibres having an average diameter different from (e.g. lower than) the previous layer. If this movement is continuous, the average diameter of the produced fibres continuously decreases (or increase) along one dimension (e.g. the thickness) of the fibrous structure. The variation of the fibres diameter in any section perpendicular to said dimension, may be limited, e.g. below 10%. In systems whereby the fibrous structure is moving during displacement of the outlets in the vertical direction with respect to the receiving surface, the variation of the diameter in a section perpendicular to the thickness dimension depends on the speed of movement. The slower the movement of the receiving surface, the smaller the variation over a given surface will be.

Some examples for inducing a fibre thickness profile are moving the set of outlets perpendicularly (e.g. in the z direction) to said receiving surface, moving the receiving surface vertically (e.g. in the z direction) towards or away from the set of outlets or both, moving the set of outlets and the receiving surface towards each other or away from each other. The distance between the outlets and the receiving surface can advantageously be varied between 1 and 100 cm, more advantageously between 4 cm and 100 cm. This first embodiment enables to implement a fluctuation of the average fibre diameter as a function of thickness of the obtained fibrous structure. As the fibrous structure is formed by exposing it long time in the electrospun system or by re-exposing it, the system gives rise to batch type processing.

In FIG. 2, an example of electrospinning device according to this first embodiment to provide a predetermined distance profile, e.g. an optionally monotonously, decreasing or increasing distance between the outlets and the receiving surface is presented together with geometrical axes x, y and z. The z axis is the vertical axis while the x and the y axis defines two horizontal axis perpendicular to each other. This device comprises a high voltage source 1 and a pump 2 (e.g. a peristaltic pump, an anesthesia pump or a container kept under constant pressure with pressurized air). The device also comprises an upper element 7 with a set of outlets 5 (here needles) which are positioned horizontally in a planar fashion. The device also comprise a receiving surface 8 adapted to repeatedly move in the X direction (an endless belt). The device further comprises means 11 for transferring/providing a solution or melt to the outlets and means 10 for providing a relative movement (here a monotonous vertical movement in the Z direction and a reciprocating movement in the Y direction) to the set of outlets 5 with respect to the receiving surface 8. The device is surrounded by a surrounding element 9 (here transparent). The device further comprises evacuation means 15 to remove solvent. The evacuation means can be connected to a chimney or to a solvent recuperation system. In the example of FIG. 2, the high voltage source 1 is a DC-source able to apply a potential difference between 100 and 200.000 V over a spinneret, said spinneret consisting of two elements 7 and 8 arranged in parallel against each other. The upper element 7 is a plate comprising a certain amount of holes in which metallic needles 5 are positioned. The needles are electrically in contact with each other through the metallic plate 7. In another setup a semi or non-conductive upper plate 7 can be used in combination with a conductive (e.g. metallic) wire connecting all the needles 5. The high voltage source 1 is connected to the upper plate 7, when electro-conductive, or to the wire that interconnects all needles 5. The lower plate 8 is either a metallic plate, foil or textile structure, which optionally can be coated with a perforated or non-perforated polymer/plastic layer. This plate is grounded. Optionally it can be used as ungrounded (floating) but this can cause unsafe situations. In another embodiment the upper and lower plate are inverted, thus the needles are positioned in the lower plate and polymer jets move upwards the device.

The device depicted in FIG. 2 can be operated as follows: A voltage is set between the outlets 5 and the receiving surface 8. A liquid or melt to be electrospun is transferred from a recipient to the outlets 5 via the transfer means 11 (here a flexible tube) by the action of means 2 for providing a solution or melt to the outlets. In order to induce a distance profile between the outlets and the receiving surface during electrospinning operation, the relative movement can be obtained by moving the outlets (and therefore also here the upper plate) in the Z direction by the operation of movement means 10 for moving the set of outlets, or for moving the receiving surface. It is this movement that allows a predetermined profile of the fibre diameter variation along the thickness of the obtained fibrous structure (e.g. a mat). The distance between the outlets and the receiving surface can preferably be varied between 1 and 100 cm. The actual border values that will be used depend on the specification of the product to be obtained. Simultaneously, the endless belt 8 is accumulating the fibrous structure formed. In this way, a predetermined distance profile, e.g. an, optionally monotonously, decreasing or increasing distance between the outlets and the receiving surface, while the receiving surface is moved relatively to said outlets in one direction parallel to said receiving surface, can be obtained. Simultaneously, the upper plate 7 comprising the outlets is moved reciprocally in the Y direction between two inversion points in order to assure a good overlap of the solution or melt output (also called nanofibre umbrellas). Those umbrellas have a tendency to reject each other, which is detrimental to their overlap in the absence of reciprocal movement in the Y-direction. This reciprocal movement is therefore particularly preferred. Additionally, the use of a reciprocal movement in the Y-direction permits to increase the width of the nanofibrous structures. The movement of the receiving surface 8 allows the production of large nanofibrous structure surface areas.

The device of FIG. 2 permits the production of fibrous structures wherein the fibre diameter varies according to a predetermine profile, e.g. monotonously along the thickness of the obtained fibrous structure, although the invention is not limited thereto. The predetermined profile of the fibre diameter may for example also be a larger diameter at the surfaces of the fibrous structure, a smaller diameter at the surfaces of the fibrous structure or any other desired profile. The diameter variation obtained can be continuous or discontinuous. If discontinuous, the fibrous structures produced will appear layered. This first embodiment is not adapted for the continuous production of fibrous structures. The two next embodiments advantageously permit the continuous production of fibrous structures according to the present invention, which is often preferred over batch production.

A second embodiment to provide a predetermined distance profile, e.g. an, optionally monotonously, decreasing or increasing distance between the outlets and the receiving surface is to arrange a plurality of outlet sets along the direction of the lengthwise production of said fibrous structures, wherein the outlets are arranged in the lengthwise production of the fibrous structure according to a predetermined profile. For example, each outlet set is at a distance to the receiving surface lower than the next outlet set along said lengthwise direction (see FIG. 3), which would result in a decreasing or increasing profile, e.g. monotonously increasing or decreasing profile. An obvious alternative for the particular example of increasing or decreasing profile is of course to arrange a plurality of outlet sets along the direction of the lengthwise growth of said fibrous structures, wherein each outlet set is at a distance to the receiving surface higher than the next outlet set along said direction. Those two alternatives have the advantage that they allow the continuous production of large nanofibrous structure surface areas while the embodiment of FIG. 2 only permits the batch-wise production of fibrous structures.

In FIG. 3, an example of an electrospinning device according to this second embodiment to provide a predetermined profile, e.g. an, optionally monotonously, decreasing or increasing distance between the outlets and the receiving surface is presented together with geometrical axes x, y and z. The z axis is the vertical axis while the x and the y axis define two horizontal axis perpendicular to each other. This device is composed of two outlet sets 5, each connected to a high voltage source 1 and to a pump 2 (here hidden in a box), which are positioned horizontally in a planar fashion. The device also comprises a receiving surface 8 (an endless belt) adapted to move in the X direction below both sets of outlets. The system also comprises means 11 for transferring/providing a solution or melt to the outlets. Means 10 for providing a movement of the set of outlets 5 with respect to the receiving surface 8 are here not necessary but could be provided additionally. Such means 10 could be useful to adapt the distance between each set of outlets and the receiving surface to the specific fibrous structure to be produced. The electrospinning device of FIG. 3 is particularly well suited to continuous production, particularly to the continuous production of layered fibrous structures. In other words, the number of layers with different fibre diameters in the laminated structure determines the number of modules (outlets sets) necessary, which in principle is unlimited (FIG. 3 shows a device comprising two modules). In addition, the use of a range of modules connected to each other contributes positively to the high-throughput production possibilities of such laminated nanofibrous structures.

In operation, the device depicted in FIG. 3 operates as follows: A voltage is set between each set of outlets 5 and the receiving surface 8. A liquid or melt to be electrospun is transferred from a recipient to each of the set of outlets 5 via the transfer means 11 (here a flexible tube) by the action of means 2 for providing a solution or melt to the outlets. The receiving surface is moved continuously in the X direction while collecting the fibrous structure formed from said receiving surface. While progressing in the X direction, the receiving surface is exposed to the output of outlets, e.g. monotonously, closer to it. Simultaneously, the outlets are moved reciprocally in the Y direction to give a good overlap of the outputs of the outlets on the receiving surface.

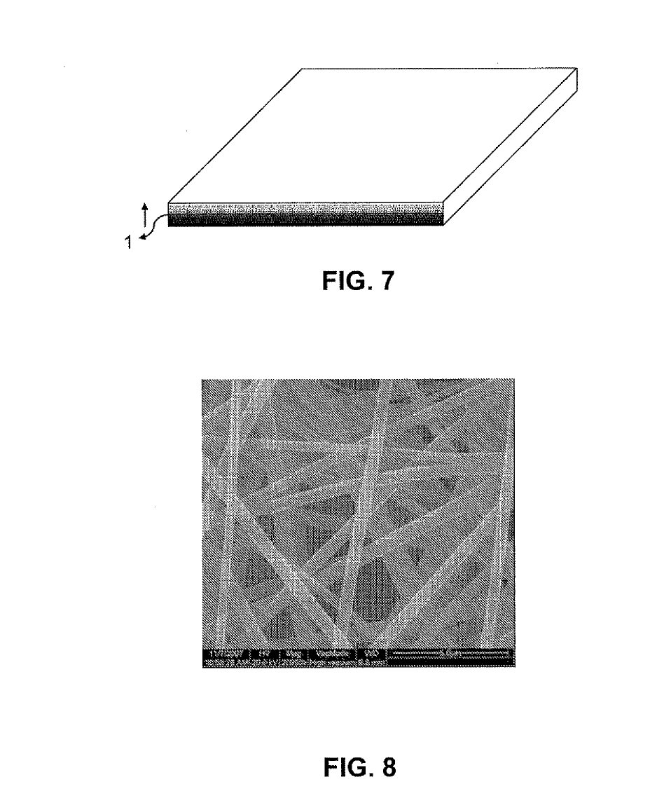

A third embodiment to provide a predetermined distance profile, such as for example a decreasing or increasing distance profile, between the outlets and the receiving surface is to arrange the outlets in such a way that the outlets are comprised in a plane not horizontal relatively to the receiving surface. While in the device of the second embodiment to provide a predetermined distance profile, for example decreasing or increasing distance, between the outlets and the receiving surface (see FIG. 3), the fibrous structures obtained are layered and at the interface between two layers the diameter of the fibres changes in a discrete way, in the third embodiment to provide a predetermined distance profile, such as for example decreasing or increasing distance, between the outlets and the receiving surface, fibrous structures can be obtained wherein the change in diameter within a dimension of the fibrous structure is smoother, e.g. a continuous variation of the diameter across the thickness of the produced fibrous structure can be obtained. In one example, the outlet sets are arranged in such a way that the outlets are comprised in a plane not horizontal to the receiving surface is to incline the set of outlets (e.g. the upper plate comprising them) at an angle between 5 and 50° relatively to the receiving surface (often relatively to the horizontal). This results in a continuously increasing or decreasing outlet (e.g. needle tip) to receiving surface distance (for each row of needles) along the x-direction, i.e. along the direction of the lengthwise growth of the fibrous structure. Preferably, each outlet is oriented perpendicularly to the receiving surface despite said angle, although the invention is not limited thereto. An example of this third embodiment to provide a predetermined distance profile between the outlets and the receiving surface is schematically presented in FIG. 4. With this setup laminated nanofibrous structures can be continuously produced that show a smooth profile of the average nanofibre diameter as a function of depth (FIG. 7), while for the setup of FIG. 3. only discrete changes of the nanofibre diameter are obtained at the interfaces between the individual layers.

In FIG. 4, an example of electrospinning device according to this third embodiment to provide a predetermined distance profile between the outlets and the receiving surface is presented together with geometrical axes x, y and z. The z axis is the vertical axis while the x and the y axis defines two horizontal axis perpendicular to each other. This device is composed of two planar outlet sets 7, each connected to a high voltage source 1 and to a pump 2 (here hidden in a box), which are, in the present example, positioned slantwise to the receiving surface 8. It is to be noticed that an alternative distance profile also may be applied. The receiving surface 8 is adapted to move in the X direction below both sets of outlets. The system also comprises means 11 for transferring/providing a solution or melt to the outlets. Means 10 for providing a movement of the set of outlets 5 with respect to the receiving surface 8 are here not necessary but could be provided additionally. Such means 10 could be useful to adapt the slope of the planar outlet sets 7 in order to create different variation of the distance between each set of outlets and the receiving surface. This adaptation permits different specific fibrous structure to be produced with the same device.

In operation, the device depicted in FIG. 4 operates as follows: A voltage is set between each set of outlets 5 and the receiving surface 8. A liquid or melt to be electrospun is transferred from a recipient to each of the set of outlets 5 via the transfer means 11 (here a flexible tube) by the action of means 2 for providing a solution or melt to the outlets. The receiving surface is moved continuously in the X direction while collecting the fibrous structure formed. While progressing in the X direction, the receiving surface is exposed to the output of outlets position at a different distance, e.g. closer to it. Simultaneously, the outlets are moved reciprocally in the Y direction to give a good overlap of the outputs of the outlets on the receiving surface.

In some embodiments, the electrospinning device of the present invention comprises movement means for moving the set(s) of outlets and/or said receiving surface, such as but not limited to one or more motors and one or more actuation means, such as e.g. transmission axis. The movement means may be adapted for inducing one or more of the relative movements as described above.

The device may comprise a controller for controlling said movement means and therefore for controlling the movement of the outlets and the receiving surface during the production process of the fibrous structure or for setting the distance and/or the slope of each set of outlets according to the target fibrous structure so that a variation of the distance is obtained during the production process of the fibrous structure. The controller may be particularly adapted for controlling the electrospinning system so that a distance variation between the outlets and the receiving surface is obtained during the production process of the fibrous structure, e.g. in a single electrospinning process. The latter may be performed without halting the electrospinning process and/or without substantial delay between deposition of nanofibres with a different diameter. The delay between the deposition of nanofibres with a different diameter may be less than 60 seconds, advantageously less than 10 seconds, more advantageously less than 1 s. In an advantageous embodiment, no delay is present between the deposition of nanofibres with a different diameter. A controller may be made in hardware as well as in software. It may be adapted to perform a controlling, synchronisation or adaptation step for performing a method for electrospinning as can be performed using a system as described above. The present invention also relates to such a controller as such. The controller may comprise a processing means and may be particularly dedicated for performing tasks of control of an electrospinning system as set out above.

It is an advantage of embodiments according to the present invention that, using an electrospinning system as described above, variation of the distance between the outlet (tip) and collector (receiving surface) can be performed during an electrospinning experiment, so that substantially no or no delay occurs between deposition of nanofibre materials at the receiving surface having a different diameter. The latter results in the advantage that a strong nanofibrous structure is obtained, without the risk that this falls apart during normal use or when an intermediate force is applied to it.

It is an advantage of embodiments according to the present invention that such electrospinning systems provide nanofibrous structures having a good reproducibility and a good mechanical strength.

In a second aspect, the present invention relates to a method for producing fibrous structures. This method comprises the steps of providing a set of outlets for outputting solution or melt, providing a receiving surface for receiving output from said set of outlets, moving said receiving surface in a first direction parallel to said receiving surface, applying a potential difference, i.e. a voltage between said set of outlets and said receiving surface, during said moving and applying, providing a solution or melt to the outlets. According to embodiments of the present invention, during said providing a solution or melt to the outlets, a variation in the distance between outlets of the device and the receiving surface according to a predetermined profile is present, in order to obtain a predetermined fibre thickness profile over the fibrous structure. The predetermined profile may be an optionally monotonously, decreasing profile along said first direction. This profile may be obtained because of the geometry of the system (e.g. embodiments of FIGS. 3 and 4) or because of an actual relative movement of the set of outlets relatively to the receiving surface. Further features regarding the presence of a variation in the distance between at least some outlets of the device and the receiving surface according to a predetermined profile may be as set out in the first aspect.

It is an advantage of embodiments according to the present invention that by the presence of a variation between outlets and the receiving surface during the deposition, a good interaction, albeit not chemical, between the different nanofibres is obtained so that a good adhesion between the nanofibres occurs and structures with good mechanical strength are obtained. Due to the possibility for preparing the structure in a single electrospinning session, the adhesion between the different fibres can be sufficiently good so that a firm structure is built up, while not resulting e.g. in cross-linked fibres. More particularly, by depositing a next layer of fibres when the previously deposited layer is still somewhat wet, e.g. the fluid content may be between 2% and 6% or e.g. between 2% and 5%, the different fibres tend to stick slightly to each other, whereby the sticking interaction is a weak interaction, not being chemical interactions and not being cross-linking. The method may advantageously be performed with a system as described in the first aspect.

The potential difference may be selected in the range between 100 and 200000 V. The movement step may be performed by actuating means for further moving said set of outlets and/or said receiving surface to generate a good filling of the fibrous structure. As a result, at least one of the receiving surface and the set of outlets is further moved. The further movement of the outlets may be a reciprocal movement, e.g. a movement between two fixed points, Advantageously, the receiving surface is further moved continuously in a direction parallel to said receiving surface. Advantageously, the set of outlets is further moved reciprocally in a first direction parallel to the receiving surface and the receiving surface is further moved in a second direction parallel to the receiving surface but different from said first direction. For instance, the receiving surface can be further moved at an angle to the first direction such as optionally substantially perpendicular to said first direction. Said first and second direction may be perpendicular to each other and parallel to said first plane and said receiving surface. Advantageously, the set of outlets and the receiving surface are further moved relatively to each other so that the set of outlets moves along the y-direction (see for instance FIG. 2, FIG. 3 or FIG. 4) between two inversion points and the receiving surface further moves continuously in a direction perpendicular to the y-direction (e.g. the x-direction in FIG. 2, FIG. 3 or FIG. 4) but in the plane of said receiving surface. The set of outlets may further move with an average speed between 0.1 cm s⁻¹ and 100 cm⁻¹. The receiving surface may move with a speed between 10 cm h⁻¹ and 100 m h⁻¹.

The solution or melt may be kept in a recipient which may but does not have to be temperature controlled. Providing the solution or melt can be performed by solution or melt actuating means for providing the solution or melt to the outlets. Those means (such as e.g. a pump) transfer the solution or melt to the outlets via transfer means which may but do not have to be temperature controlled. Once at an outlets, the solution or melt forms a droplet from which a filament will be drawn and projected toward the receiving surface under the action of the potential difference. The receiving surface acts therefore as a collecting surface. The shape of the jet of solution or melt leaving an outlet is usually conical and forms a so-called umbrella, i.e. a covered area on the receiving surface.

It is an advantage of embodiments according to the present invention that the variation of the distance between outlets of the system and the receiving surface is present during the electrospinning experiment, as this allows obtaining nanofibrous structures having a variation in diameter, e.g. layered nanofibrous structures with sub-layers having nanofibres with different diameter, while still having a mechanically strong nanofibrous microstructure.

According to an embodiment of the present aspect, the method for electrospinning also may comprise obtaining variation of other parameters for electrospinning in view of the variation of nozzle outlet to collector distance. Other parameters that may be varied may for example be the applied voltage, the humidity, the flow rate of the melt or solution provided to the nozzles. Solution or melt parameters thereby may be taken into account or also may be varied. Such parameters may for example be the concentration of a polymer used, the charge density, the solvent used and/or the viscosity. Such adjustment or optimization may be performed experimentally. In principle it already provides a significant advantage to optimize the applied voltage when varying the distance between the nozzle outlets and the collector. Variation of one or more parameters may be performed in agreement with predetermined rules, according to calculated models, based on trial and error experiments, or in any other suitable way. Optimisation may for example be performed by adjusting the parameters until a steady-state is reached. The steady state may be defined by the point where the Taylor cone is constant and spinning can be performed in a continuous way. Detection of such a steady state may be obtained optically, e.g. visually or using an optical detector, and adjusting of the parameters may be performed manually or in an automatic and/or automated way.

It is an advantage of embodiments according to the present invention that, using such control, adjustment and/or optimization of process parameters, a beads-free fibrous structure can be obtained, while varying the diameter of the fibres in the structure within the same electrospinning session. It is an advantage of embodiments according to the present invention that by taking into account above-identified parameters, the window where nanofibres, e.g. fibres without beads being present or with only a limited amount of beads being present, can be produced under steady state conditions. It is an advantage that a large process window can be obtained, wherein the risk of having a large number of beads on the nanofibres or even the risk of not producing nano-fibres anymore is reduced or even avoided. Obtaining a large process window for operating in a steady state conditions results in the possibility of producing nanofibres in a highly reproducible way and in continuous mode.

In a third aspect, the present invention relates to a fibrous structure. A first embodiment of a fibrous structure according to the present invention shows a number of advantages and innovative aspects when compared to the commonly described nanofibrous structures of the prior art. These features are obtained through the specificity of the used electrospinning devices according to the first aspect of the present invention. The fibrous structures of the present invention shows a variation of the diameter of its individual fibres along a dimension of the fibrous structure, e.g. across the thickness of the fibrous structure. In an embodiment, the present invention relates to an electrospun fibrous structure comprising fibres, wherein the diameter of said fibres varies according to a predetermined profile, e.g. decreases or monotonously decreases along a dimension of said electrospun fibrous structure and wherein the variance of the fibres diameter in any section perpendicular to said dimension may be below 10%. The predetermined profile may for example also be such that the diameter of the fibre is minimal at an intermediate position of the fibrous structure in a depth direction of the fibrous structure. In an embodiment, the electrospun fibrous structure of the present invention is a laminated structure composed of layers of nanofibres, each subsequent layer being composed of fibres having an average diameter lower than the fibres of the previous layer. The average diameter of the fibres is therefore varying according to a predetermined profile, e.g. decreasing or increasing monotonously, across the thickness of the electrospun fibrous structure.

The electrospun fibrous structures of the present invention can be cut in any desired shape dependent on the requirements of the envisaged applications. The surface area can vary from 5 mm² to 10 m², the thickness from 100 nm to 30 cm and the diameter of the individual fibres from 3 nm to 5 μm. In an embodiment, the electrospun fibrous structure of the present invention is porous. The electrospun fibrous structures have preferably a porosity of at least 65%. The pore sizes can vary from 30 nm to 8 μm.

As an advantageous feature, the electrospun fibrous structure of the present invention may comprise a majority, i.e. 50% or more of straight fibres. In one embodiment, the fibrous structure forms a mat. The straightness of the fibres can for instance be inferred from an image analysis. Preferably, the majority of the fibres (i.e. 50% or more) comprised in the fibrous structure are straight, i.e. consists of a majority of segments (i.e. 50% or more) substantially straight over a distance of 5 μm. By substantially straight, it must be understood that the major axis of the fibre, i.e. along the direction of the fibre, changes over an angle less than 45°, e.g. less than 30°, or e.g. less than 15° or e.g. less than 5°, considering a distance of 10 micrometer over which the angle change was measured. This angle is the largest angle which can be measured between tangents at two points of the major axis over the length of the fibre considered. The standard deviation to linearity over the distance in question may be not exceeding 5%.

As an advantageous feature, the fibrous structures of the present invention may comprise only few or no cross-linking, e.g. microfibrous or nanofibrous structure wherein a majority of the fibres (i.e. 50% or more) comprised are substantially cross-link free. The fibrous structure is an electrospun fibrous structure, it is a structure made by electrospinning. They are advantageously not cross-linked to neighbouring fibres. Cross-linking thereby means that a link occurs between two fibres, not just that two fibres are touching. This is the result of the spacing between the outlets being at least 1 cm, advantageously at least 4 cm. Without being bound by theory, it is believed that this effect is due to an easier and therefore faster evaporation of the solvent during the fibres formation. It is believed that for spacing between the outlets inferior to 1 cm, the solvent takes too much time to evaporate during the fibres formation. This leads to fusing of adjacent fibres and therefore to crosslinks. If the fibrous structure is made from a melt, the problem may be an incomplete elimination of the heating effect occurring when outlets are too close to each other. The fibre formation then is not complete and a sort of intermediate phase between melt and solid then may be present, allowing formation of cross-linked fibres. Another advantageous feature of the fibrous structures obtained is that they have a porosity of at least 65%, advantageously between 65 and 99%.

It is to be noticed that cross-linking between the fibres does not comprise weak non-chemical interaction, resulting in sticking of the nanofibres and giving rise to the mechanical strength obtained in structures according to the present invention. Such interaction thus result in the positive mechanical strength of nanofibrous structures according to the present invention, while avoiding the negative effects caused by cross-linking.

In embodiments, the present invention also relates to a fibrous structure wherein the thickness of the fibres is uniform, i.e. the standard deviation of the thickness throughout the fibrous structure does not exceed 80%, advantageously 50%, most advantageously 20%

The present invention also relates to a fibrous structure comprising more or all of the above identified properties. As an optional feature, the fibrous structures according to the present invention can be made comprising a majority of fibres (i.e. 50% or more) randomly oriented, i.e. not oriented in a particular direction (e.g. not aligned). The last effect is helpful in achieving an increased porosity. In embodiments where the receiving surface moves continuously in one direction, this effect can be obtained for example by choosing a speed for the receiving surface between 10 cm h⁻¹ and 100 m h⁻¹.

As an optional feature, the diameter of a majority of the fibres (i.e. 50% or more of the fibres) comprised in the fibrous structures of the present invention have a diameter of 3 nm or higher, advantageously 10 nm or higher. As an optional feature, the diameter of a majority of the fibres (i.e. 50% or more) comprised in the fibrous structures of the present invention have a diameter of 2000 nm or lower, advantageously 800 nm or lower, most advantageously 700 nm or lower. When the fibres have an average diameter of 800 nm or lower, they will be referred to as nanofibres and the fibrous structures made there from as nanofibrous structures. As an optional feature, the diameter of a majority of the fibres (i.e. 50% or more) comprised in the fibrous structures of the present invention have a diameter of 3 to 2000 nm, advantageously between 10 and 2000 nm, advantageously between 3 and 800 nm, more advantageously a diameter of 10 to 700 nm. The fibre may have a diameter wherein the local, unintended variations are less than 100% of the diameter size over its entire length, more advantageously less than 50% of the diameter size over its entire length. Fibres are not referred to as fibres or referred to as beaded fibres when local, unintended, deviations of the diameter occur of more than 200% with respect to the average diameter.

As can be seen from the examples the fibre diameter is dependent on the distance between the outlets and the receiving surface. The profile of the relationship between the fibre diameter and the distance may be polymer and solvent specific. Therefore a profile can be determined after studying the polymer solution or melt because it is polymer and solvent specific. It can be determined via trial and error, via experimental results, via a theoretical model, etc. As another optional feature, the fibrous structures obtained have a width between 15 and 10000 cm.

In embodiments of the third aspect of the present invention, the fibrous polymeric structures have a porosity of at least 65% and a width comprised between 15 and 10000 cm.

The method of the second aspect applied to the device of the first aspect permits to obtain fibrous structures having outstanding properties, and remarkable property being the variation of the fibres diameter across a dimension of the fibrous structure.

In some embodiments of the third aspect, the fibrous structures are obtained laminated, i.e. multi-layered. Advantageously, the average fibre diameter is different for each pair of adjacent layers within the fibrous structure. This may be achieved by using a different distance between the set of outlets and the receiving surface for each layer (see e.g. FIG. 3). The obtained laminated fibrous structures have a number of advantages compared to their non-laminated counter parts. Firstly, the combination of layers with small fibre diameter and layers with somewhat bigger fibres improve on the overall strength of the fibrous structure. Secondly, the absorption/release properties of the fibrous structure can be optimized as a function of application and this in a single production step and finally, multitasking and multi-functionality can be obtained by using a laminated structure, such as multilevel filtration in one single multilayered structure.

It is to be understood that although preferred embodiments, specific constructions and configurations, as well as materials, have been discussed herein for devices according to the present invention, various changes or modifications in form and detail may be made without departing from the scope and spirit of this invention. For example, steps may be added or deleted to methods described within the scope of the present invention. Whereas the present invention has been described with respect to a method for manufacturing, an electrospinning device and the resulting fibrous structures, the present invention also relates to a controller for controlling a relative distance between the outlets and the receiving surface for generating different properties between different layers in a fibrous structure.

By way of illustration, a number of examples are discussed. Examples 1 to 3 illustrate by way of example variation of the diameter in depth of the nanofibrous structure made in a single electrospinning experiment. Examples 4 and 5 illustrate two examples wherein steady state conditions are illustrated for electrospinning of different materials. Examples 7, 9, 11 and 13 describe electrospinning experiments wherein strong nanofibrous structures are obtained using a method according to an embodiment of the present invention, whereas examples 6, 8, 10 and 12 describe comparative electrospinning experiments wherein the different sub-layers in the nanofibrous structure are obtained during different electrospinning experiments, separated in time. These examples and comparative examples illustrate advantages of embodiments according to the present invention. Example 14 describes similar results as described for examples 4 to 13 but for different materials. The latter illustrates that the methods and systems for electrospinning according to embodiments of the present invention are widely applicable and not limited strongly by the material that is electrospun.

### Example 1

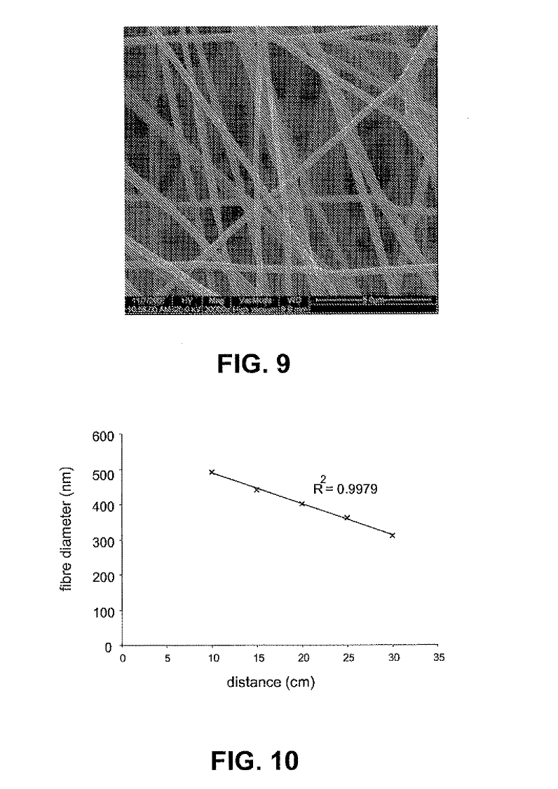

Polyester amide (PEA), obtained through synthesis from fatty acids, with molecular weight of about 20.000 g mol⁻¹ was dissolved in chloroform to obtain a solution of 25% PEA. The solution was pumped to a set of 24 outlets with a multitude of multichannel peristaltic pumps, using a flow rate of 15 mL h⁻¹ per outlet. In the spinneret an electrical field of about 1000 V cm⁻¹ is applied over the outlets and the receiving surface in order to allow electrospinning of the polymer solution. The outlets were positioned in the triangle configuration of 4 rows of 6 outlets per row. Temperature control was performed at 298 K. The outlet surface was positioned under an angle of 10° relative to the receiving surface and the outlet surface moved perpendicular to the movement of the receiving surface. The speed of the receiving surface was 40 cm h⁻¹, while the rate for the outlet surface is 1 cm s⁻¹. After 2 hours of spinning a nanofibrous structure of 300 μm thick was obtained with a length of about 1.5 m and a width of 80 cm. The average nanofibre diameter changed as a function of depth from 500 nm (FIG. 8) at one side of the structure to 300 nm (FIG. 9) at the other side. The side with the largest diameters corresponds to the fibres obtained from the outlets positioned the closest against the receiving surface, while the smallest diameters (at the other side of the nanofibrous structure) were obtained from the outlets having the largest distance from the receiving surface. FIG. 10 shows the relationship for nanofibre diameter and distance between outlets and receiving surface.

### Example 2

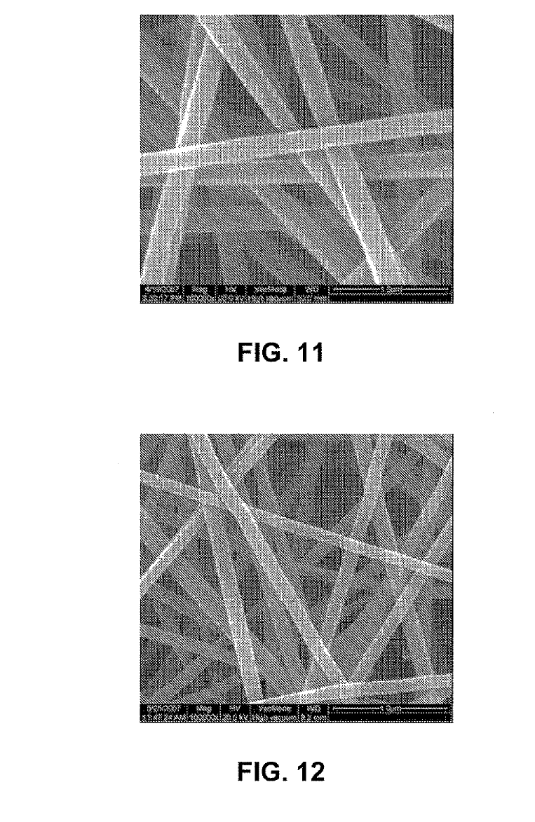

Poly amide 6/6 (PA66) with molecular weight of about 20.000 g mol⁻¹ was dissolved in formic acid to obtain a solution of 14% PA66. The solution was pumped to 2 sets of each 24 outlets with a multitude of multichannel peristaltic pumps, using a flow rate of 2 mL h⁻¹ per outlet. In the spinneret an electrical field of about 3.500 V cm⁻¹ was applied over the outlets and the receiving surface in order to allow electrospinning of the polymer solution. The outlets were positioned in the triangle configuration of 4 rows of 6 outlets per row. Two spinnerets were used, each operational at a different distance between the outlets and the receiving surface. Temperature control was performed at 298 K. The first outlet surface was positioned at a distance of 4 cm, while the second was positioned at a distance of 6 cm from the receiving surface. The speed of the receiving surface was 60 cm h⁻¹, while the rate for the outlet surface is 1 cm s⁻¹. After 2 hours of spinning a nanofibrous structure of 100 μm thick was obtained with a length of about 12 m and a width of 80 cm. The average nanofibre diameter changed in one step as a function of depth from 285 nm (FIG. 11) at one side of the structure to 180 nm (FIG. 12) at the other side. The side with the largest diameters corresponds to the fibres obtained from the outlet surface positioned at 4 cm from the receiving surface, while the smallest diameters (at the other side of the nanofibrous structure) are obtained from the outlet surface positioned at 6 cm from the receiving surface.

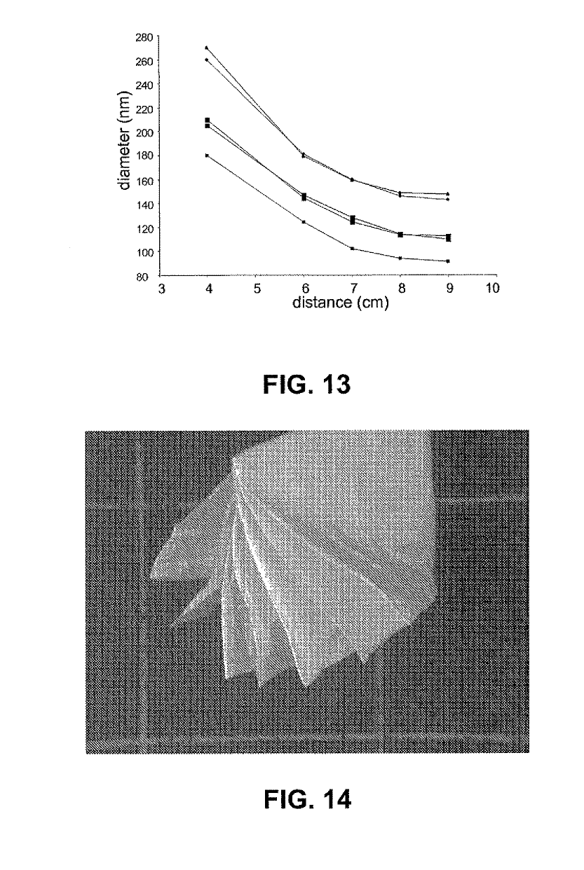

FIG. 13 shows the profile of the distance between the outlets and the receiving surface and the average nanofibre diameter, obtained using the processing setup as described in example 1. This profile is plotted for different concentrations of PA66.

### Example 3

Cellulose acetate (CA) with molecular weight of about 30.000 g mol⁻¹ was dissolved in acetone/Dimetylacetamide 2:1 to obtain a solution of 14% CA. The solution was pumped to 2 sets of each 24 outlets with a multitude of multichannel peristaltic pumps, using a flow rate of 10 mL h⁻¹ per outlet. In the spinneret an electrical field of about 850 V cm⁻¹ was applied over the outlets and the receiving surface in order to allow electrospinning of the polymer solution. The outlets were positioned in the triangle configuration of 4 rows of 6 outlets per row. Two spinnerets were used, each operational at a different distance between the outlets and the receiving surface. Temperature control was performed at 298 K. The first outlet surface was positioned at a distance of 20 cm, while the second was positioned at a distance of 15 cm from the receiving surface. The speed of the receiving surface was 60 cm h⁻¹, while the rate for the outlet surface was 1 cm s⁻¹. After 2 hours of spinning a nanofibrous structure of about 200 μm thick was obtained with a length of about 1.2 m and a width of 80 cm. The average nanofibre diameter changed as a function of depth from 470 nm at one side of the structure to 450 nm at the other side. The side with the largest diameters corresponds to the fibres obtained from the outlet surface positioned at 15 cm from the receiving surface, while the smallest diameters (at the other side of the nanofibrous structure) are obtained from the outlet surface positioned at 20 cm from the receiving surface.

### Example 4

Polyamide 6/6 (PA66) was dissolved in formic acid to obtain a solution of 14% PA66. The solution was pumped to a set of needles with a multitude of multichannel peristaltic pumps. Temperature control was performed at 298 K. The needles were positioned 6 cm from each other. A steady-state operation was obtained resulting in fibres that did not contain or had a reduced or minimum of beads using the following values for the operational parameters tip to collector distance, flow rate and applied voltage.

| Tip to collector distance | Flow rate | Applied voltage |
|---|---|---|
| 6 cm | 2 mL h−1 | 20 kV |
| 7 cm | 2 mL h−1 | 23 kV |
| 8 cm | 2 mL h−1 | 26 kV |
| 9 cm | 2 mL h−1 | 28.5 kV |
| 6 cm | 1 mL h−1 | 16.5 kV |
| 6 cm | 3 mL h−1 | 22 kV |
| 6 cm | 4 mL h−1 | 24 kV |
| 6 cm | 5 mL h−1 | 26.5 kV |

The combination of the tip to collector distance, the flow rate and the applied voltage resulted in a good steady-state condition. This condition was obtained by manually adjusting the applied voltage for a fixed tip to collector distance and for a fixed flow rate.

### Example 5

In example 5 a similar experiment as in example 4 is described. Polyesteramide, obtained through synthesis using fatty acids, was dissolved in chloroform to obtain a solution of 24% PEA. The solution was pumped to a set of needles with a multitude of multichannel peristaltic pumps. Temperature control was performed at 298 K. The needles were positioned 6 cm from each other. A steady-state operation was obtained resulting in fibres that did not contain or had a reduced or minimum of beads using the following values for the operational parameters tip to collector distance (shown in row 1), flow rate (shown in column 1) and applied voltage (expressed in kV) for the given tip to collector distance and the given flow rate.

| | |
|---|---|
| Flow | |
| rate | tip to |
| (mL | collector (cm) |

| h⁻¹) | 5 | 10 | 15 | 20 | 25 | 30 |
|---|---|---|---|---|---|---|
| 6 | 8 | 11.5 | 14 | 16 | 17 | 18.5 |
| 8 | 8 | 10.5 | 11 | 15 | 16.5 | 18 |
| 10 | 9 | 13 | 15.5 | 18 | 18 | 19 |
| 12 | 10 | 14 | 17 | 19 | 19 | 20.5 |
| 14 | 12 | 14 | 18 | 18.5 | 20 | 21.5 |
| 16 | 10 | 12.5 | 15.5 | 17 | 19 | 21 |

The combination of the tip to collector distance, the flow rate and the applied voltage indicated in the table resulted in a good steady-state condition. This condition was obtained by manually adjusting the applied voltage for a fixed tip to collector distance and for a fixed flow rate.

### Example 6

Polyamide 6/6 (PA66) was dissolved in formic acid to obtain a solution of 14% PA66. The solution was pumped to a set of needles with a multitude of multichannel peristaltic pumps, with a flow rate of 5 mL h⁻¹ per needle, an applied potential of 4500 V cm⁻¹ and a tip to collector surface distance of 6 cm. Temperature control was performed at 298 K. The needles were positioned 6 cm from each other. A first layer of nanofibres was obtained. After 10 minutes a second layer is deposited under the same conditions. This was repeated 6 times to obtain a laminated structure of 7 layers. The layers therefore were made during different electrospinning experiments, well separated in time. When applying mechanical strength to the laminated structure it showed a weak strength due to weak adhesion between the individual layers. The latter is illustrated in FIG. 14 indicating delamination of the 7 layers after application of a mechanical force.

### Example 7

Polyamide 6/6 (PA66) was dissolved in formic acid to obtain a solution of 14% PA66. The solution was pumped to a set of needles with a multitude of multichannel peristaltic pumps, with a flow rate of 5 mL h⁻¹ per needle, an applied potential of 4500 V cm⁻¹ and a tip to collector surface distance of 6 cm. Temperature control was performed at 298 K The needles were positioned 6 cm from each other. A first layer of nanofibres was obtained. Immediately a second layer was deposited under the same conditions. This was repeated 10 times to obtain a laminated structure of 11 layers, according to an embodiment of the present invention. When applying mechanical strength to the laminated structure it showed a strong strength and coherent nanofibrous mat in which individual layers could not be detected. The latter is illustrated in FIG. 15 indicating that no delamination of the structure occurs.

Comparison between example 6 and example 7 illustrates that nanofibrous structures obtained using embodiments according to the present invention have the advantage of having a good strength and good structure.

### Example 8

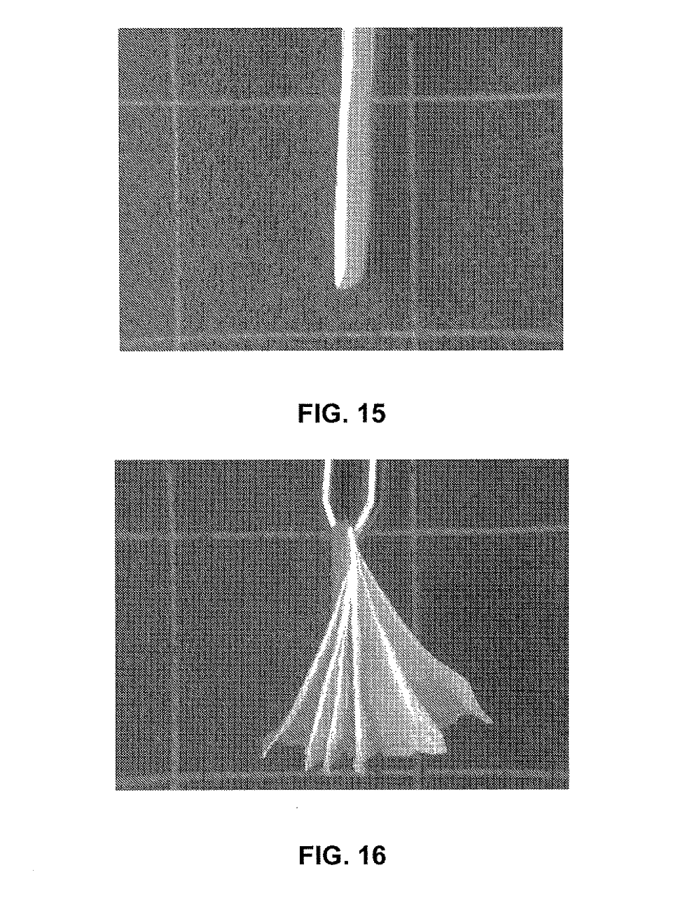

Polyamide 6/6 (PA66) was dissolved in formic acid to obtain a solution of 14% PA66. The solution was pumped to a set of needles with a multitude of multichannel peristaltic pumps, with a flow rate of 2 mL h⁻¹ per needle, an applied potential of 3500 V cm⁻¹ and a tip to collector surface distance of 6 cm. Temperature control was performed at 298 K. The needles were positioned 6 cm from each other. A first layer of nanofibres was obtained. After 10 minutes a second layer was deposited at 2 mL h⁻¹, an applied potential of 3300 V cm⁻¹ and a tip to collector surface distance of 7 cm. Again 10 minutes later a layer was deposited under the following conditions: flow rate of 2 mL h⁻¹ per needle, an applied potential of 3500 V cm⁻¹ and a tip to collector surface distance of 6 cm. Finally a fourth, fifth and sixth layer was deposited under the following conditions, each with a time interval of 10 minutes: flow rate of 2 mL h⁻¹ per needle, an applied potential of 3300 V cm⁻¹ and a tip to collector surface distance of 7 cm. The layers thus were made during different electrospinning experiments, well separated in time. When applying mechanical strength to the laminated structure it showed a weak strength due to weak adhesion between the individual layers. The latter is illustrated in FIG. 16, again indicating delaminating of the structure.

### Example 9

Polyamide 6/6 (PA66) was dissolved in formic acid to obtain a solution of 14% PA66. The solution was pumped to a set of needles with a multitude of multichannel peristaltic pumps, with a flow rate of 2 mL h⁻¹ per needle, an applied potential of 3500 V cm⁻¹ and a tip to collector surface distance of 6 cm. Temperature control was performed at 298 K. The needles were positioned 6 cm from each other. A first layer of nanofibres was obtained. Immediately a second layer was deposited at 2 mL h⁻¹, an applied potential of 3300 V cm⁻¹ and a tip to collector surface distance of 7 cm. Followed by a third layer under the following conditions: flow rate of 2 mL h⁻¹ per needle, an applied potential of 3500 V cm⁻¹ and a tip to collector surface distance of 6 cm. Finally a fourth, fifth and sixth layer was deposited instantaneously under the following conditions: flow rate of 2 mL h⁻¹ per needle, an applied potential of 3300 V cm⁻¹ and a tip to collector surface distance of 7 cm. The nanofibrous structure therefore was obtained substantially within a single electrospinning experiment, whereby between the electrospinning deposition of the different sub-layers resulting in nanofibres with different diameter, no substantial temporal delay was present, according to embodiments of the present invention. When applying mechanical strength to the laminated structure it showed a strong strength and coherent nanofibrous mat in which individual layers could not be detected. A result similar as the one shown in FIG. 15 was obtained.

Comparison between example 8 and example 9 again illustrates that nanofibrous structures obtained using embodiments according to the present invention have the advantage of having a good strength and good structure. Furthermore, from the different chemical composition, it can be seen that these results are not substantially dependent on the chemical composition of the materials used.

### Example 10

Polyesteramide was dissolved in chloroform to obtain a solution of 24% PEA. The solution was pumped to a set of needles with a multitude of multichannel peristaltic pumps, with a flow rate of 12 mL h⁻¹ per needle, an applied potential of 750 V cm⁻¹ and a tip to collector surface distance of 25 cm. Temperature control was performed at 298 K. The needles were positioned 6 cm from each other. A first layer of nanofibres was obtained. After 10 minutes a second layer is deposited under the same conditions. This was repeated 10 times to obtain a laminated structure of 11 layers. The layers therefore were made during different electrospinning experiments, well separated in time. When applying mechanical strength to the laminated structure it showed a weak strength due to weak adhesion between the individual layers.

### Example 11

Polyesteramide, obtained through synthesis using fatty acids was dissolved in chloroform to obtain a solution of 24% PEA. The solution was pumped to a set of needles with a multitude of multichannel peristaltic pumps, with a flow rate of 12 mL h⁻¹ per needle, an applied potential of 750 V cm⁻¹ and a tip to collector surface distance of 25 cm. Temperature control was performed at 298 K. The needles were positioned 6 cm from each other. A first layer of nanofibres was obtained. Immediately a second layer was deposited under the same conditions. This was repeated 10 times to obtain a laminated structure of 11 layers, according to an embodiment of the present invention. When applying mechanical strength to the laminated structure it showed a strong strength and coherent nanofibrous mat in which individual layers could not be detected.

Comparison between example 10 and example 11 illustrates that for different types of electrospinning solutions again nanofibrous structures obtained using embodiments according to the present invention have the advantage of having a good strength and good structure. The latter also confirms that the methods and systems according to embodiments of the present invention result in good structures, substantially independent of the materials used.

### Example 12

Polyesteramide, obtained through synthesis using fatty acids was dissolved in chloroform to obtain a solution of 24% PEA. The solution was pumped to a set of needles with a multitude of multichannel peristaltic pumps, with a flow rate of 12 mL h⁻¹ per needle, an applied potential of 750 V cm⁻¹ and a tip to collector surface distance of 25 cm. Temperature control was performed at 298 K. The needles were positioned 6 cm from each other. A first layer of nanofibres was obtained. After 10 minutes a second layer was deposited at 12 mL h⁻¹, an applied potential of 1400 V cm⁻¹ and a tip to collector surface distance of 10 cm. Again 10 minutes later a layer was deposited under the following conditions: flow rate of 12 mL h⁻¹ per needle, an applied potential of 750 V cm⁻¹ and a tip to collector surface distance of 25 cm. Finally a fourth layer was deposited under the following conditions: flow rate of 12 mL h⁻¹ per needle, an applied potential of 1400 V cm⁻¹ and a tip to collector surface distance of 10 cm. The layers thus were made during different electrospinning experiments, well separated in time. When applying mechanical strength to the laminated structure it showed a weak strength due to weak adhesion between the individual layers.

### Example 13

Polyesteramide, obtained through synthesis using fatty acids was dissolved in chloroform to obtain a solution of 24% PEA. The solution was pumped to a set of needles with a multitude of multichannel peristaltic pumps, with a flow rate of 12 mL h⁻¹ per needle, an applied potential of 750 V cm⁻¹ and a tip to collector surface distance of 25 cm. Temperature control was performed at 298 K. The needles were positioned 6 cm from each other. A first layer of nanofibres was obtained. Immediately a second layer was deposited at 12 mL an applied potential of 1400 V cm⁻¹ and a tip to collector surface distance of 10 cm. Followed by a third layer under the following conditions: flow rate of 12 mL h⁻¹ per needle, an applied potential of 750 V cm⁻¹ and a tip to collector surface distance of 25 cm. Finally a fourth layer was deposited instantaneously under the following conditions: flow rate of 12 mL h⁻¹ per needle, an applied potential of 1400 V cm⁻¹ and a tip to collector surface distance of 10 cm. The nanofibrous structure therefore was obtained substantially within a single electrospinning experiment, whereby between the electrospinning deposition of the different sub-layers resulting in nanofibres with different diameter, substantially no temporal delay was applied, according to embodiments of the present invention. When applying mechanical strength to the laminated structure it showed a strong strength and coherent nanofibrous mat in which individual layers could not be detected.

Comparison between example 12 and example 13 again illustrates that nanofibrous structures obtained using embodiments according to the present invention have the advantage of having a good strength and good structure.

### Example 14

In order to illustrate the substantial independence of the electrospinning solution used for the obtained advantages when using systems and/or applying methods according to embodiments of the present invention, the above experiments were repeated using the following polymers: polystyrenes, polycaprolactones, polyacrylonitriles, polyethylene oxides, polylactic acids, polyacrylic acids, polyesteramides, polyvinyl alcohols, polyimides, polyurethanes, polyvinylpyrrolidon, collagen, cellulose and related products, chitosan, methacrylates, silk, metal containing nanofibres, Polyethylene vinyl alcohol copolymer and polyethylene vinyl acetate copolymer. Similar results and advantages could be seen.

According to another aspect, the present invention relates to a wound dressing device for controlling fluids near at least one wound, e.g. exudates from a wound. Controlling fluids may comprise controlling the amount of fluid being present near the wound. Controlling fluids near the wound may comprise controlling a lateral flow of fluids near the wound. Controlling fluid may comprise absorbing fluid from at least one wound. The wound dressing device may be especially suitable for wound dressing of burn wounds, although the invention is not limited thereto. The wound dressing device comprises a nanofibrous structure comprising a plurality of fibres. The nanofibrous structure may be made using any of the methods as described in other aspects as described in the present application. The nanofibrous structures may be the same or similar as any of the nanofibrous structures described in embodiments or aspects as described in the present application. The nanofibrous structure may comprise a contact surface for contacting the wound. The diameter of the fibres of the nanofibrous structure varies in a direction perpendicular to the contact surface in order to control fluid uptake from and/or fluid release to the wound. Such a variation may be a difference of diameter of the fibres between different layers in a multi-layer structure and/or a more continuous variation of the diameter of the fibres. The variation may be a variation in porosity, a variation in fibre density and/or a variation in density of the fibres. In particular aspects, the variation of the porosity, diameter of the fibres or density of the fibres may be according to a predetermined variation profile in order to provide a predetermined uptake and/or release profile of exudates by the wound dressing device. The profile may be such that there is a quick uptake at the contact side between the wound and the wound dressing device and a quick transport from that side to the opposite side so that the wound is substantially dried. Another profile may be that there is an uptake at the contact side between the wound and the wound dressing, a transport into the dressing up to a certain depth and if the fluid release by the wound slows down fluid earlier taken up and stored in the dressing may be released back to the wound. The wound dressing device may for example have a profile with a larger fibre diameter at the wound contact surface, a smaller fibre diameter in the middle of the wound dressing device, and again a larger diameter at the opposite surface. The profile may be such that the wound dressing device comprises a central reservoir for fluids which may be released back to the wound at a later stage, e.g. to prevent the wound from being too dry.

The nanofibrous structure advantageously is a porous structure. The structure may have a porosity, e.g. an average porosity, of at least 65%. The porosity, e.g. average porosity, may be between 65 and 99%, advantageously between 70 and 98 and more advantageously between 75 and 95%. The nanofibrous structure may for example be able to absorb water, a solution, a compound or a gel for an equivalent of 1 to 25 times its own weight. It may for example have a liquid uptake capacity between 3 and 25 times its own weight, advantageously between 4 and 25 times and more advantageously between 5 and 25 times, for a liquid with a density of about 1 kg/l. It is an advantage of embodiments according to the present invention that a high absorption capacity can be obtained based exclusively on the high porosity of the structure. In particular embodiments according to the present invention, the nanofibrous structure furthermore may comprise an active liquid absorbing and/or gel forming compound for further increasing the liquid uptake capacity. Such an active liquid absorbing and/or gel forming compound may result in a liquid absorption capacity of between 1 and 70 times its own weight. Such an active liquid absorbing and/or gel forming compound may for example be applied as a coating onto the individual nanofibres, although the gel forming compound also may be added in a different way to the nanofibrous structure. One example of an active water absorbing and/or gel forming compound may for example be polyacrylic acid, the present invention not being limited thereto.

The pore sizes can vary from 30 nm to 8 μm. According to some embodiments of the present invention, the pore size of at least a section of the nanofibrous structure may be selected to be smaller than 150 nm, e.g. smaller than 125 nm or smaller than 100 nm. Bacteria typically have dimensions larger than 150 nm. Therefore such structures, once applied at the surface to be treated and/or protected, form an excellent barrier for bacteria preventing the surface to be treated getting infected.

The nanofibrous structure may comprise nanofibres such that at least 30%, advantageously at least 50% of the nanofibres of the nanofibrous structure have an average diameter between 3 and 2000 nm. The nanofibrous textile structure, deposited at the substrate, may have an average thickness between 1 μm and 5000 μm, advantageously between 1 μm and 2000 μm, advantageously between 10 and 2000 nm, advantageously between 3 and 800 nm, more advantageously a diameter of 10 to 700 nm. The diameter of a majority of the fibres (i.e. 50% or more of the fibres) comprised in the fibrous structures of the present invention may have a diameter of 3 nm or higher, advantageously 10 nm or higher. As an optional feature, the diameter of a majority of the fibres (i.e. 50% or more) comprised in the fibrous structures of the present invention have a diameter of 2000 nm or lower, advantageously 800 nm or lower, most advantageously 700 nm or lower. For the present application, fibres with diameters with one of the suggested diameter or within one of the diameter ranges will be referred to as nanofibres, and the corresponding structures may be referred to as nanofibrous structures. In embodiments, the present invention also relates to a fibrous structure wherein the thickness of the fibres is uniform, i.e. the standard deviation of the thickness throughout the fibrous structure does not exceed 80%, advantageously 50%, more advantageously 20%. The fibre diameter is dependent on the distance between the outlets and the receiving surface. The profile of the relationship between the fibre diameter and the distance may be polymer and solvent specific. Therefore a profile can be determined after studying the polymer solution or melt because it is polymer and solvent specific. It can be determined via trial and error, via experimental results, via a theoretical model, etc. The individual nanofibres may have a length between 10 μm and 50 m.

The nanofibrous structure may comprise at least 50% of straight fibres wherein the fibres have segments substantially straight over a distance of at least 5 μm. The straightness of the fibres can for instance be inferred from an image analysis. Preferably, the majority of the fibres (i.e. 50% or more) comprised in the fibrous structure are straight, i.e. consists of a majority of segments (i.e. 50% or more) substantially straight over a distance of 5 μm. By substantially straight, it must be understood that the major axis of the fibre, i.e. along the direction of the fibre, changes over an angle less than 45°, e.g. less than 30°, or e.g. less than 15° or e.g. less than 5°, considering a distance of 10 micrometer over which the angle change was measured. This angle is the largest angle which can be measured between tangents at two points of the major axis over the length of the fibre considered. The standard deviation to linearity over the distance in question may be not exceeding 5%.

As an advantageous feature, the fibrous structures of the present invention may comprise only few or no cross-linking, e.g. microfibrous or nanofibrous structure wherein a majority of the fibres (i.e. 50% or more) comprised are substantially cross-link free. They are advantageously not cross-linked to neighbouring fibres. Cross-linking thereby means that a link occurs between two fibres, not just that two fibres are touching. This is the result of the spacing between the outlets being at least 1 cm, for example being at least 4 cm. Without being bound by theory, it is believed that this effect is due to an easier and therefore faster evaporation of the solvent during the fibres formation. It is believed that for spacing between the outlets inferior to 1 cm, the solvent takes too much time to evaporate during the fibres formation. This leads to fusing of adjacent fibres and therefore to cross-links. If the fibrous structure is made from a melt, the problem may be an incomplete elimination of the heating effect occurring when outlets are too close to each other. The fibre formation then is not complete and a sort of intermediate phase between melt and solid then may be present, allowing formation of cross-linked fibres.

The nanofibrous structure may comprise at least 50% of randomly oriented fibres. In one embodiment, the fibrous structure forms a mat.

Advantageously the nanofibrous structure may be obtained through electrospinning of a material. Fibres with the features as indicated may be obtained by an electrospinning technique with a multi-nozzle system. The nozzles may be separated at an inter-distance of at least 1 cm, advantageously an inter-distance of at least 4 cm.

A large range of materials can be used to produce the nanofibrous structure, among them polymers from the following polymer classes: polyamides, polystyrenes, polycaprolactones, polyacrylonitriles, polyethylene oxides, polylactic acids, polyacrylic acids, polyesteramides, polyvinyl alcohols, polyimides, polyurethanes, collagen, cellulose and related products, chitosan, methacrylates, silk, polyethylene vinyl acetate co polymer, polyethylene vinyl alcohol co polymer, polyvinylbutyral and metal containing nanofibres.

The wound dressing devices may have any suitable shape. They may be made in a squared or rectangular shape, but can also be cut in alternative shapes dependent on the requirements of the envisaged applications. The surface area can vary from 5 mm² to 10 m². The wound dressing devices may be suitable for wound bum dressing or dressing for large wounds, the nanofibrous structure having a contacting surface of at least 30 cm by 30 cm, advantageously 40 cm by 40 cm and more advantageously 50 cm by 50 cm. But the dressing may also be used for small wounds, the nanofibrous structure having contacting surface as small as 2 mm by 2 mm, or 5 mm by 5 mm and more advantageously 20 mm by 20 mm. The wound dressing device may be cuttable in any shape by hand or with a machine using mechanical, thermal or laser induced cutting. The thickness of the device, typically measured in a direction perpendicular to the contact surface, may be between 100 nm and 30 cm, for example between 50 μm and 5000 μm.

The nanofibrous structure of the wound dressing device may be fixed to a substrate. The substrate may be substantially larger than the nanofibrous structure and may be provided with adhesive properties, e.g. by provision of glue, at the edges in order to stick the wound dressing device to skin around the wound. Alternatively or in addition hereto such adhesive properties also may be provided directly to edges of the nanofibrous structure, with or without the substrate being present.

By way of illustration, the present invention not being limited thereto, a number of particular embodiments will be discussed, illustrating optional features and advantages of embodiments according to the present invention.

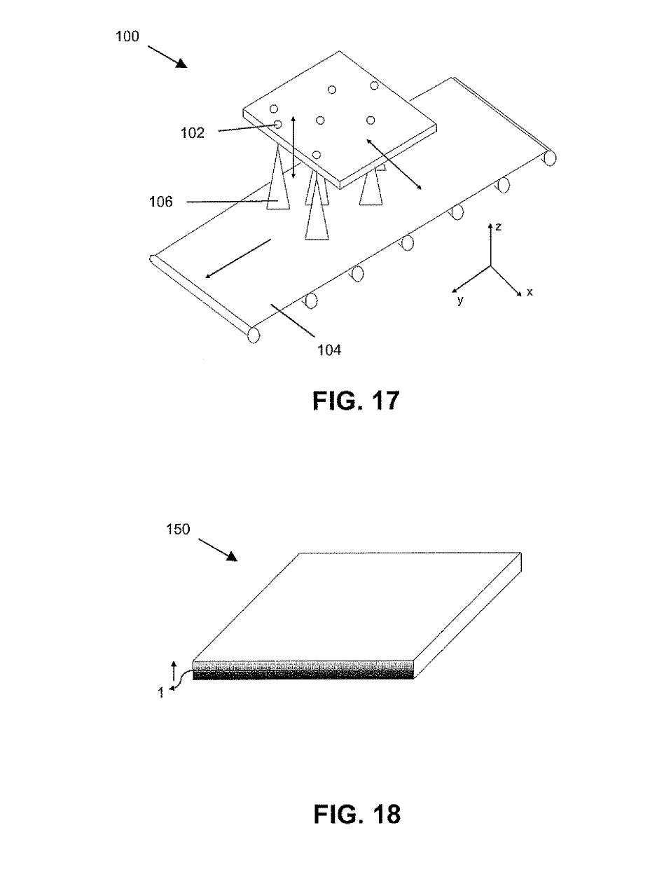

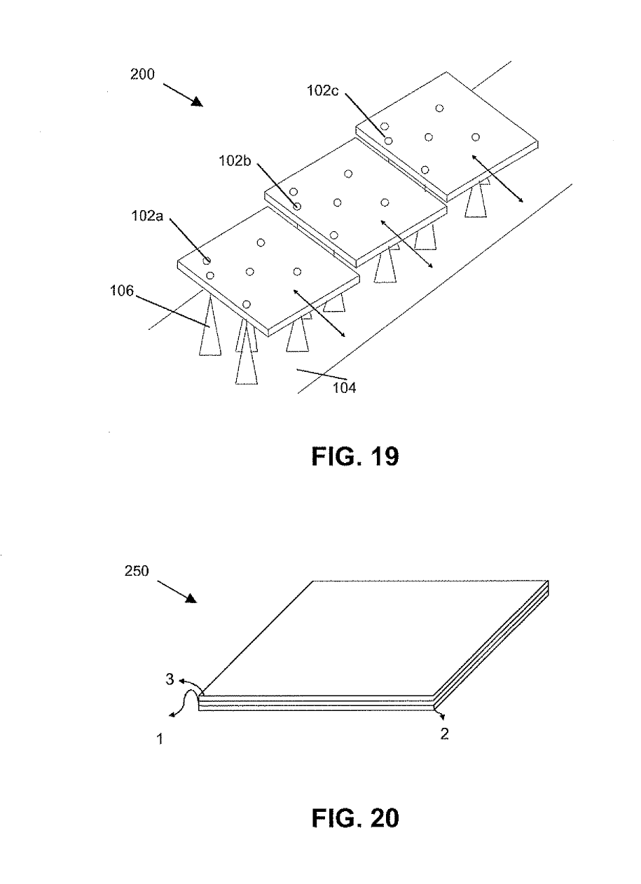

In a first particular embodiment, a wound dressing device as described above is discussed. In these wound dressing devices, the diameter of the nanofibres may be varied in a controlled way as a function of depth in the nanofibrous structure. By varying the diameter of the nanofibres across the depth of the nanofibrous structure, i.e. in a direction perpendicular to the contact surface for the wound dressing device, a good and controllable uptake of liquids and/or (bio)active compounds can be obtained. The fibres may be made of the same material throughout the nanofibrous structure or they may be made of different materials. Advantageously the nanofibrous structure may be obtained through electrospinning of a material. Fibres with the features as indicated may be obtained by an electrospinning technique with a multi-nozzle system. The nozzles may be separated at an inter-distance of at least 1 cm, e.g. at least 4 cm or at least 6 cm. Furthermore, for controlling the diameter, the distance between the nozzles and the receiving surface may be adapted. By way of illustration, the present invention not being limited thereto, a number of electrospinning methods for manufacturing a wound dressing device with a variable diameter are described. In a first setup for manufacturing a wound dressing device using an electrospinning method, the distance between nozzles of the electrospinning device and a collector surface of an electrospinning device can be varied during processing, which results in a variation of the diameter of the individual nanofibres. The latter is shown in more detail in FIG. 17. FIG. 17 illustrates part of an electrospinning setup 100 comprising a set of nozzles 102 and a collector surface 104. Between the nozzles 102 and the collector surface 104 a voltage is applied, e.g. by using a voltage source (not shown). The relative nozzle position may be moved laterally in all directions, which may provide appropriate overlap between the different fibres generated. Furthermore, the system is adapted for providing a distance variation between the nozzles outlet and the collector surface. FIG. 17 also shows the conically shaped spraying area 106 wherein material is sprayed. The collector surface 104 may be or may be part of a moving surface. In a second setup a variation of the nanofibre diameter is obtained by producing a laminated structure of layers, each layer being produced at a constant nozzle-collector surface distance. The latter is schematically shown in more detail in FIG. 19. FIG. 19 illustrates a similar setup as in FIG. 17, wherein the variation of the distance between the nozzles outlet 102 and the collector surface 104 in the electrospinning setup 200 is not provided by movement of the nozzle outlets 102, but by providing a plurality of different nozzle outlet sets 202a, 202b, 202c which are at a different distance with respect to the collector surface 104. Variation of other parameters for electrospinning in view of the variation of the nozzle outlet to collector distance, such as for example the voltage to be applied, may for example be determined experimentally. Whereas in principle it already provides a significant advantage to optimize the applied voltage when varying the distance between the nozzle outlets and the collector, furthermore also other parameters such as for example the flow rate of the starting materials may be adjusted. The latter may be performed in agreement with predetermined rules, according to calculated models, based on trial and error experiments, or in any other suitable way. Optimisation may for example be performed by adjusting the parameters until a steady-state is reached. The steady state may be defined by the point where the Taylor cone is constant and spinning can be performed in a continuous way. A Taylor cone is the typical triangle shape obtained when a pending drop of polymer solution is brought into an electrical field. Detection of such a steady state may be obtained optically, e.g. visually or using an optical detector, and adjusting of the parameters may be performed manually or in an automatic and/or automated way. According to examples of the present embodiment, nanofibrous structures may be obtained having nanofibres of small diameter, e.g. between 3 nm and 1.5 μm, at one side and nanofibres of larger diameter, e.g. between 50 nm and 5 μm, at the other side, e.g. the contact side. It is clear that with a first setup a continuous or quasi-continuous variation of the nanofibres diameter as a function of depth can be obtained, a corresponding wound dressing device 150 shown in FIG. 18, while for the second setup a number of discrete steps in diameter variation will be obtained, a corresponding wound dressing device 250 being shown in FIG. 20. In advantageous embodiments, the diameter of the fibres in the nanofibrous structure decreases from the contact side of the wound dressing device to the opposite side thereof.

It is an advantage of embodiments of the present invention that small pore sizes can be obtained, allowing to evaporate absorbed liquid in the structure efficiently due to the high specific surface area of the nanofibrous structure. It may be clear that the most efficient evaporation properties will be obtained at that side of the device where the nanofibres with the smallest diameter are present because it is at that side that the highest specific surface area is obtained and that the transport rate of liquid towards that surface is maximal.

Another advantage of embodiments according to the present invention may be that the wound dressing device is not only able to absorb high amounts of liquids at the contact side or evaporate the fluid at another side, but that the liquid taken up at one side (contact side or contact surface) of the wound dressing device (for example from an exudating wound) is transported efficiently towards the other side of the structure on the condition that the wound dressing device is used in the appropriate way, i.e. that it is positioned so that the nanofibres with the largest diameter are present at the contact surface whereas the nanofibres with the smallest diameter should be present at the side opposite to the contact surface. This means that the diameter of the nanofibres should decrease over the cross section of the device in the direction from liquid uptake side to the liquid releasing side.

It also is an advantage of embodiments according to the present invention that due to the possibility for preparing the electrospun wound dressing device in a single electrospinning session, the adhesion between the different fibres can be sufficiently good so that a firm structure is built up, while not resulting e.g. in cross-linked fibres. More particularly, by depositing a next layer of fibres when the previously deposited layer is still somewhat wet, e.g. comprise between 2 and 6 percent moisture, the different fibres tend to stick slightly to each other, whereby the sticking are weak interaction, not being chemical interactions and not being cross-linking. It is furthermore an advantage of embodiments according to the present invention that a beads-free fibrous structure can be obtained, while varying the diameter of the fibres in the wound dressing device within the same electrospinning session. The latter may for example be obtained by controlling the different parameters during the electrospinning session, while varying the nozzle-collector distance.

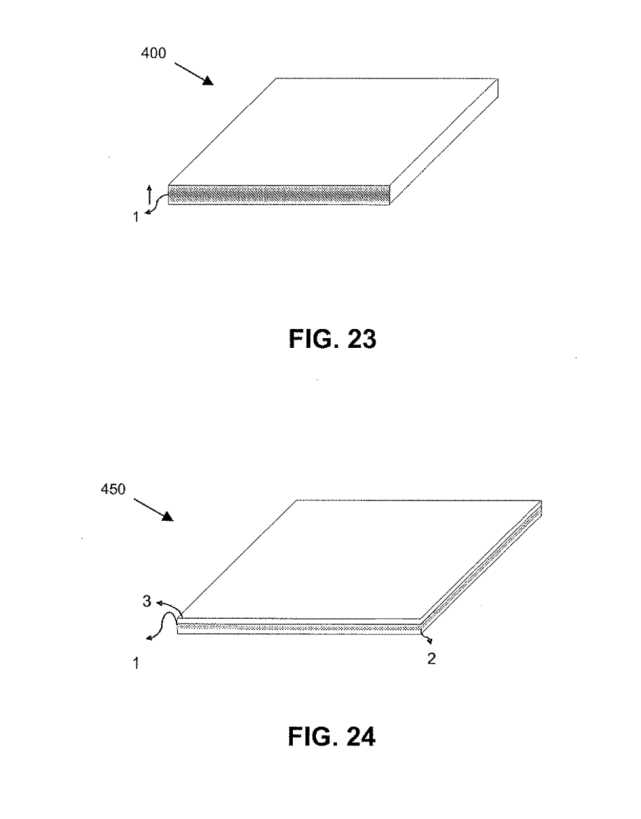

It is an advantage of embodiments according to the present invention that wound dressing devices are provided that are able to absorb liquid from a surface efficiently (for example an exudating wound) and establish a dynamic removal regimen of the liquid based on efficient absorption of the liquid, efficient transport of liquid over the cross-section of the device and efficient release by evaporation at the other side of the device. In addition, it is an advantage of embodiments that fluid taken up earlier can be released back to the wound when the fluid formation process is finished. Supported by these three advantages, the liquid removal properties of the device may provide a possibility to keep a liquid releasing surface nearly dry or to keep a steady state in the actual amount of fluid present at the surface of the wound. In other advantageous embodiments, the device is suitable for preventing the wound from being dried completely. Two examples of such wound dressing devices are shown in FIG. 23 and FIG. 24, illustrating wound dressing devices adapted for taking up liquids from the wound, storing these and releasing it back to the wound at a later stage. FIG. 22 shows a corresponding wound dressing device 400 wherein the diameter varies continuously as can be obtained with a system as shown in FIG. 17, whereas FIG. 24 shows a laminated structure 450 as can be obtained with a system as shown in FIG. 19. Both structures have at an intermediate position in the direction perpendicular to the contact surface fibres with a diameter smaller than the diameter of fibres closer to the contact surface and smaller than the diameter of fibres closer to the surface opposite to the contact surface. In the device according to FIG. 24, an intermediate layer having such fibres is provided. Such embodiments have the advantage that these allow controlling an amount of fluid near the wound so that the wound does not become dry, which may be advantageous for some types of wounds.

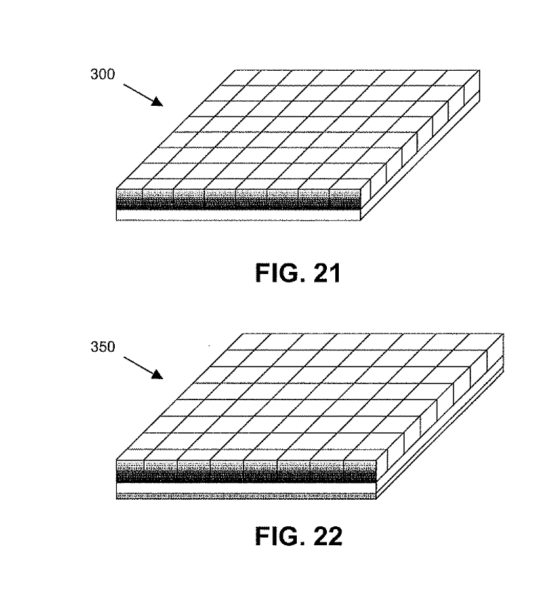

In a second particular embodiment, the nanofibrous structure furthermore is adapted for preventing or reducing the risk that neighbouring wounds, treated with the same dressing can infect each other due to short cutting of the wounds by the wound dressing device. This disadvantage occurs if one of the wounds is infected before application of the device. The latter is solved in the present embodiment by using a nanofibrous structure as described above, wherein furthermore at least the top part of the nanofibrous structure, i.e. the part to be faced towards the wound, is patterned. One example of such a patterned structure 300 may be as shown in FIG. 21, although the invention is not limited thereto. Different types of patterning may be provided.

The patterning of at least the top part of the nanofibrous structure may be performed such that the wound dressing device surface for contacting the wound is separated in a plurality of smaller areas. The magnitude of these areas may be the same for all areas or may be variable. A preferred size of the individual area may be 5 cm by 5 cm, preferably 2 cm by 2 cm and more preferably 1 cm by 1 cm. The patterning of the nanofibrous structure or a part thereof may be obtained in any suitable way, such as for example by treating it with heat according to a pattern to be formed. For example, a heated patterned structure may be used for inducing such a pattern in the nanofibrous structure or part thereof. Due to the heat, the pattern will be burnt into the layer because locally nanofibres will melt and stick together. It might be clear that in those sections the structure looses its nanofibrous properties. At these borders, liquid thus cannot be transported easily from one area to an adjacent area within the pattern, thus resulting in a reduction or even prevention of infected wound liquid of one wound area being coming into contact with another wound area. In other words, lateral barriers are made in order to prevent lateral flow of wound liquid. Another advantage of lateral barriers that these may prevent wound fluid from transferring to healthy skin near the wounds, as these advantageously should be kept dry. It is to be noticed that, the idea of providing lateral barriers in nanofibrous structures also can be used for nanofibrous structures wherein no variation in fibre diameter occurs in the direction in-depth of the nanofibrous structure, i.e. the direction perpendicular to the contact surface of the nanofibrous structure.

In a nanofibrous structure according to the present particular embodiment, liquid cannot go from one area to another area of the pattern, thus sections relatively close to each other cannot be wetted starting from one liquid releasing source. For example for wound burns it means that a wound burn will not be infected by a neighbouring wound burn, treated with the same device, because exudates cannot be transported to the neighbouring zones.

It may be an advantage to combine a patterned layer (in contact with the surface to be treated) with a common layer as described for the first embodiment. The wound moisture then is eliminated through the patterned layer and given to the common layer where it can spread out and evaporate relatively easily. The latter combines the advantage of preventing cross-contamination between wounds and a large moisture uptaking capacity by the common layer as well as a good evaporation so that the moisture can leave the nanofibrous structure easily. Liquid transported from the patterned layer to the non-patterned region will not flow back into the patterned layer because of the variation in nanofibre diameter, decreasing along the cross-section from the liquid uptake side (in contact with the patterned layer) to the side where liquid is released by evaporation.

Alternatively, using an intermediate non-patterned region with larger fibre diameters will allow the storage of liquid in the patterned sections of the patterned layer and thus allow the option of releasing liquid back to the wound if necessary to maintain a steady state in actual liquid present at the surface of the wound. An example of a wound dressing device 350 according to this principle is shown in FIG. 22.

Liquid barriers also may be used for preventing liquid to be removed too much from the wound dressing device. Using such a patterning promotes the possibility to store the fluid released by the wound in the dressing for later release back to the wound. This allows maintaining a steady state in actual fluid at the wound surface, which was found through a survey among wound burn centres in Europe to be advantageously for the wound healing process and kinetics.

In a third particular embodiment, a nanofibrous structure as described in any of the previous embodiments is disclosed, wherein furthermore an antibacterial and/or biocide property is added to the nanofibrous structure. By doing so, the nanofibrous structure advantageously can provide an antibacterial and/or biocide action, which may be especially useful if the surface to be treated is infected before applying of the structure. As the size of the pores in the nanofibrous structure may be small, bacteria may be remaining at the wound and uptake of the bacteria may be not possible due to the pore size. According to embodiments of the present invention, the antibacterial and/or biocide property may be provided by providing a layer of nanofibres comprising an antibacterial and/or biocide property. Such a layer may be obtained by coating nanofibres with an antibacterial and/or biocide material or by electrospinning fibres of such a material. The layer of nanofibres comprising such material may advantageously be positioned at the liquid uptake side, thus this layer may directly contact the surface to be treated. The layer thus may comprise nanofibres of an active compound with antibacterial and/or biocide properties, for example polyvinylpyrrolidon (PVP), containing I₂. When applied to a surface, the fibres may dissolve in the liquid released by the surface, which may activate the envisaged compound that kills the bacteria. In an advantageous embodiment, more than one layers of nanofibres comprising an antibacterial and/or biocide property may be added, so that the antibacterial and/or biocide effect may be prolonged. The latter may be obtained by the fact that such layers positioned further away from the wound will induce the antibacterial and/or biocide property at a later moment in time.

In a further aspect, the present invention relates to the use of nano-fibrous structures as described in embodiments of the present invention for use in wound dressing applications. The use may benefit from one or more of the different features and advantages as set-out above for the devices in the first aspect.

In still another aspect, the present invention relates to a method for wound dressing, the method comprising obtaining a nanofibrous structure having a contact surface for contacting the wound and wherein the diameter of the fibres varies in a direction perpendicular to the contact surface according to a predetermined profile. The method furthermore comprises positioning the nanofibrous structure by contacting the wound with the nanofibrous structure in a predetermined direction. Other method steps may be present, expressing the functionality of one, more or all features of the wound dressing device as described in the first aspect of the present invention.

According to still another aspect, the present invention relates to a teeth whitening system for whitening teeth. The system for whitening teeth comprises two parts. A first part comprises a nanofibrous structure. A second part comprises a teeth whitening moiety comprising a bleaching agent. The nanofibrous structure may be used for keeping the teeth whitening moiety during use of the system for bleaching teeth. In other words, the nanofibrous structure may act as a carrier for the teeth whitening moiety during use. The nanofibrous structure may be provided to a plurality of teeth for teeth whitening, also referred to as teeth bleaching. The structure of the nanofibrous structure may be adapted so that it can appropriately absorb, keep and release moiety with a viscosity between 10 cps and 1000 cps, advantageously between 10 cps and 400 cps, more advantageously between 10 cps and 199 cps. The nanofibrous structure may be made using any of the methods as described in other aspects as described in the present application. The nanofibrous structures may be the same or similar as any of the nanofibrous structures described in embodiments or aspects as described in the present application.

The nanofibrous structure may be supported by a substrate layer, although the invention is not limited thereto. The optional substrate layer can be any material that is certified for use in the mouth. It may for example be a material that can adapt to the shape of the teeth such as aluminum foil because it is suitable for nanofibrous deposition in the electrospinning method and it keeps its shape after bending over the teeth. Nevertheless, the nanofibrous structure also may itself be adapted in structure so that it can keep its shape when provided on the teeth.

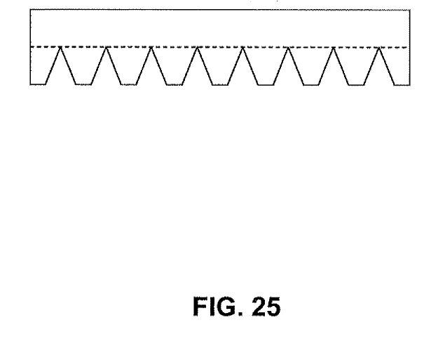

The nanofibrous structure may be adapted for fitting to a plurality of teeth, e.g. a row of front teeth. The nanofibrous structure may be responsible for the adhesive effect between this layer and the surface of the teeth based on its high contact surface area. The nanofibrous structure may be adapted in structure for having an adhesive effect of the device on the teeth. The teeth to be treated may comprise incisor teeth. Advantageously, the structure is adapted for treating the incisor teeth as well as the canine teeth simultaneously. In an advantageous embodiment, the structure may be adapted for covering the tips of the canine teeth, e.g. in combination with a coverage of the incisor teeth. The nanofibrous structure may be adapted for being fixed at a front side of the teeth using a first part and for being fixed to a back side of the teeth using a second part. The drawing in FIG. 25 refers to an exemplary first part of the system composed of an optional substrate coated with a nanofibrous structure, e.g. a nanofibrous structure. At one side of the first part of the device triangles are cut out to allow bending of the first part of the device and fit the areas that are left to the back side of the teeth. The full area of the first part of the device is brought onto the front surface of the teeth. Initially, the first part of the device is flat but when applied to the teeth it bends and fits perfectly to the shape of the teeth. The feature to bend it over the teeth and to allow a triangle shape being fit at the backside, a perfect fit with the teeth shape is finally obtained through the fact that the nanofibre layer is a very porous, compressible and fluffy structure, thus surrounds perfectly around the shape of each individual tooth.

The device has a length between 0.5 and 15.0 cm, more preferably between 2 and 10 cm and most preferably between 4 and 8 cm and a width between 0.3 and 5.0 cm, more preferably between 0.5 and 4 cm and most preferably between 1 and 3 cm. At one length side of the first part of the device triangles are cut out in order to allow easy bending and fitting of the first part of the device over the teeth. These triangles penetrate in the first part of the device with a deepness between 0.1 and 2.0 cm, more preferably between 0.3 and 1.5 and most preferably between 0.5 and 1 cm and have legs with a length between 0.13 and 2.5 cm, more preferably between 0.4 and 2.0 cm and most preferably between 0.7 and 1.3 cm. In an alternative embodiment the edges of the strip are rounded to avoid possible injuries in the mouth. Other suitable shapes for the device also may be provided.

The nanofibrous structure may comprise nanofibres such that at least 30%, advantageously at least 50% of the nanofibres of the nanofibrous structure have an average diameter between 3 and 2000 nm. The nanofibrous textile structure, deposited at the substrate, may have an average thickness between 1 μm and 5000 μm, advantageously between 1 μm and 2000 μm, advantageously between 10 and 2000 nm, advantageously between 3 and 800 nm, more advantageously a diameter of 10 to 700 nm. The diameter of a majority of the fibres (i.e. 50% or more of the fibres) comprised in the fibrous structures of the present invention may have a diameter of 3 nm or higher, advantageously 10 nm or higher. As an optional feature, the diameter of a majority of the fibres (i.e. 50% or more) comprised in the fibrous structures of the present invention have a diameter of 2000 nm or lower, advantageously 800 nm or lower, most advantageously 700 nm or lower. For the present application, fibres with diameters with one of the suggested diameter or within one of the diameter ranges will be referred to as nanofibres, and the corresponding structures may be referred to as nanofibrous structures. In embodiments, the present invention also relates to a fibrous structure wherein the thickness of the fibres is uniform, i.e. the standard deviation of the thickness throughout the fibrous structure does not exceed 80%, advantageously 50%, more advantageously 20%. The fibre diameter is dependent on the distance between the outlets and the receiving surface. The profile of the relationship between the fibre diameter and the distance may be polymer and solvent specific. Therefore a profile can be determined after studying the polymer solution or melt because it is polymer and solvent specific. It can be determined via trial and error, via experimental results, via a theoretical model, etc. The individual nanofibres may have a length between 10 μm and 50 m.

The fibre material can be any suitable material, such as for example polyamides, polystyrenes, polycaprolactones, polyacrylonitriles, polyethylene oxides, polylactic acids, polyacrylic acids, polyesteramides, polyvinyl alcohols, polyimides, polyurethanes, collagen, cellulose and related products, chitosan, methacrylates, silk, polyethylene vinylacetate co polymer, polyethylene vinylalcohol copolymer, polyvinylbutyral and metal containing nanofibres. The nano-fibrous structure also may comprise fibres comprising a pH regulating material, as will be described further in the application. Other components of the device also could be introduced in the nanofibrous structures, e.g. by spinning particular nanofibres thereof. The nanofibrous structure may comprise fibres made of polyimide made by electrospinning using a mixture of formic acid and acetic acid. The ratio of formic acid and acetic acid may be between 90/10 and 10/90 weight percent, preferably between 30/70 and 70/30 weight percent and more preferably between 40/60 and 60/40 weight percent. It may advantageously be a 50/50 weight percent ratio. It is an advantage of a ratio of around 50/50 weight percent that a steady state continuous production and a high flow rate is possible.

The structure may have a porosity, e.g. an average porosity, of at least 65%. The porosity, e.g. average porosity, may be between 65 and 99%, advantageously between 70 and 98 and more advantageously between 75 and 95%. The pore sizes can vary from 30 nm to 8 μm. The nanofibrous structure may for example be able to absorb water, a solution, a compound or a gel for an equivalent of 3 to 12 times its own weight.

The nanofibrous structure may comprise at least 50% of straight fibres wherein the fibres have segments substantially straight over a distance of at least 5 μm. The straightness of the fibres can for instance be inferred from an image analysis. Preferably, the majority of the fibres (i.e. 50% or more) comprised in the fibrous structure are straight, i.e. consists of a majority of segments (i.e. 50% or more) substantially straight over a distance of 5 μm. By substantially straight, it must be understood that the major axis of the fibre, i.e. along the direction of the fibre, changes over an angle less than 45°, e.g. less than 30°, or e.g. less than 15° or e.g. less than 5°, considering a distance of 10 micrometer over which the angle change was measured. This angle is the largest angle which can be measured between tangents at two points of the major axis over the length of the fibre considered. The standard deviation to linearity over the distance in question may be not exceeding 5%.

As an advantageous feature, the fibrous structures of the present invention may comprise only few or no cross-linking, e.g. microfibrous or nanofibrous structure wherein a majority of the fibres (i.e. 50% or more) comprised are substantially cross-link free. Cross-link free thereby may be that there is absence of covalent bonds linking one polymer chain of one fibre to another polymer chain of a neighbouring fibre. The distance between the three or more outlets also may be adapted for obtaining a fibrous structure comprising at least 50% of fibres substantially free of any chemical bound. They are advantageously not cross-linked to neighbouring fibres. Cross-linking thereby means that a link occurs between two fibres, not just that two fibres are touching. This is the result of the spacing between the outlets being at least 1 cm. Without being bound by theory, it is believed that this effect is due to an easier and therefore faster evaporation of the solvent during the fibres formation. It is believed that for spacing between the outlets inferior to 1 cm, the solvent takes too much time to evaporate during the fibres formation. This leads to fusing of adjacent fibres and therefore to crosslinks. If the fibrous structure is made from a melt, the problem may be an incomplete elimination of the heating effect occurring when outlets are too close to each other. The fibre formation then is not complete and a sort of intermediate phase between melt and solid then may be present, allowing formation of cross-linked fibres. Relatively weak physical interactions such as Van Der Waals interactions or hydrogen bridges are not covered by the definition of cross-links.

The nanofibrous structure may comprise at least 50% of randomly oriented fibres. In one embodiment, the fibrous structure forms a mat.

Advantageously the nanofibrous structure may be obtained through electrospinning of a material. Fibres with the features as indicated may be obtained by an electrospinning technique with a multi-nozzle system. The nozzles may be separated at an inter-distance of at least 1 cm, e.g. at least 4 cm. Furthermore, for controlling the diameter, the distance between the nozzles and the receiving surface may be adapted. Varying the distance during electrospinning may allow obtaining a variable diameter of the fibres in the nano-fibrous structure. Variation of other parameters for electrospinning in view of the variation of the outlet collector distance, such as for example the voltage to be applied, may for example be determined experimentally.

In particular embodiments according to the present invention, the nano-fibrous structure may have a variation in porosity, diameter of the fibres or density of the fibres in one or more dimensions, such as for example in the depth direction of the nanofibrous structure, i.e. over the cross-section, and/or in the surface direction of the nanofibrous structure, i.e. in a plane along the surface of the nanofibrous structure which is suitable for contacting with the teeth. The variation of the porosity, diameter of the fibres or density of the fibres may be according to a predetermined variation profile in order to provide a predetermined release profile of the teeth whitening moiety or more particularly a bleaching agent thereof. The variation may be obtained according to features of the methods as set out in other aspects above and the resulting nanofibrous structure may have one, some or all of the features of nanofibrous structures as described in embodiments according to other aspects of the present application.

In one example, the porosity of the nanofibrous structure may increase from the side contacting the substrate layer to the side that will contact the surface of the teeth. Variation in porosity, diameter of the fibres or density of the fibres may be obtained continuously or stepwise. In one example, such a variation may be obtained by using a laminated nanofibrous structure comprising at least two layers of nanofibres having a different diameter.

Providing a predetermined profile in density, porosity or diameter thus may provide a predetermined rate of release of the teeth bleaching agent, which may be advantageous for providing a treatment according to a predetermined profile, e.g. with a uniform bleaching agent release. Other profiles also may be provided. For example, release of a large portion, e.g. about 40% to 50%) of the bleaching agent may be provided during an initial period, e.g. the first 4 minutes, while the remaining portion may be released over a larger period of time, e.g. the following 9 minutes, in a subsequent period. In one aspect, the present invention also relates to a nanofibrous structure as described in embodiments of the present invention adapted for use in a teeth whitening application. The same features and advantages related to the nanofibrous structure as described in these embodiments also apply to this aspect of the invention.

As indicated above, the teeth whitening moiety comprises a bleaching agent, which may be the active component for bleaching a tooth or a plurality of teeth or an agent comprising such a component or able to release or generate such a component. The bleaching agent, sometimes also referred to as bleaching compound, may be a peroxide, such as for example hydrogen peroxide or a hydrogen peroxide generating product, calcium peroxide or a calcium peroxide or a combination thereof. The bleaching agent also may be a peroxide generating compound such as carbamide peroxide, perborates, percarbonates, oxyacids, an/or combinations of these chemicals. For example, the bleaching component concentration, e.g. hydrogen peroxide concentration that may be used may be between 0.1 and 35 weight percent of the teeth whitening moiety, preferably between 1 and 25 weight percent of the teeth whitening moiety and more preferably between 3 and 16 weight percent of the teeth whitening moiety. The concentrations of the bleaching agent, e.g. hydrogen peroxide, may be adopted in that way that the concentration of active component, e.g. the hydrogen peroxide, may be between 0.1 weight percent and 35 weight percent, preferably between 1 weight percent and 25 weight percent and more preferably between 3 weight percent and 16 weight percent.

The teeth whitening moiety may comprise a filling compound. The filling compound may comprise one or more of glycerine, sorbitol, polyethylene glycol or propylene glycol.

The teeth bleaching structure also may comprise a pH regulation compound, which is a regular and state of the art standard buffer. It may for example be any or a combination of sodium hydroxide, hydrogen chloride, sodium phosphate, sodium bicarbonate, sodium stannate, citric acid or sodium citrate, the invention not being limited thereto. The pH setting agent in the moiety may be between 0.1 weight percent and 10 weight percent. In some embodiments, the pH regulating agent may be provided directly in the teeth bleaching moiety. As the activity, the stability and the decomposition of the bleaching agent often depends on the pH of the moiety in which it is present, a pH regulating agent may be added to have an optimized activity of the bleaching agent. Nevertheless, providing a pH regulating agent immediately in the teeth bleaching moiety results the need for a trade-off between little activity of the bleaching agent during storage and sufficient activity of the bleaching agent during use. Such a trade-off nevertheless limits the on-the-shelve lifetime of the teeth bleaching product, or at least the lifetime during which the system is most efficient.

According to preferred embodiments of the present invention separate delivery of the pH regulating agent and the bleaching agent may be provided. For storage of the bleaching agent, the pH of the moiety wherein the bleaching agent is stored is chosen so as to have a low decomposition rate, such as e.g. in a moiety with pH of about 5, so that the bleaching agent is quite stable. Upon mixing with the pH regulating agent, when preparing for use or using, the pH of the moiety can shifts to 7.5-8.0 due to the functioning of the pH regulating agent. The latter may for example occur when the teeth whitening agent is taken up by the nano-fibrous structure to or in which the pH regulating agent is provided. At this pH the bleaching agent is less stable but also more active in bleaching. Therefore it is advantageous to use a pH around 7.5 for bleaching but a pH clearly below 6 for storage.

One particular solution to overcome the storage problem is provided in one embodiment, where the pH regulating agent is applied as a powder on the nanofibrous structure or on the substrate carrying the nanofibrous structure if present. Alternatively or in addition thereto the bleaching agent may be provided separately to the nanofibrous structure or the substrate supporting it. In a more preferred embodiment the pH regulating agent is provided in the fibres of the nanofibrous structure. The latter may for example be obtained by adding the appropriate amount of pH regulating material to the solution for making the nanofibrous structure, e.g. the electrospinning solution. The latter has the advantage that the different actions needed to be performed by the user are limited and that the different components that need to be stored separately before use or preparation thereof can be limited or reduced.

The teeth whitening moiety may be a gel. It may comprise a gel forming material. The gel forming material may have a concentration lower than 0.1 weight percent of the teeth whitening moiety, e.g. lower than 0.09 weight percent of the teeth whitening moiety. The gel forming material may comprise any or a combination of carboxymethylcellulose, carboxypropylcellulose, gum, poloxamer, or carboxypolymethylene. It is an advantage of embodiments according to the present invention that the use of gel reduces or prevents occurrence of leakage. The latter may increase the comfort for the user. It may for example result in a reduction of irritation of parts of the mouth surrounding the teeth.

The teeth whitening moiety may comprise a taste product, in order to promote a good taste when teeth bleaching is performed. Examples of such taste products may for example be spearmint/peppermint.

It is an advantage of embodiments according to the present invention that the viscosity of the teeth whitening moiety may be relatively low. The viscosity may be between 10 and 1000 cps, advantageously between 10 cps and 400 cps, more advantageously between 10 cps and 199 cps. It is an advantage of embodiments according to the present invention that methods and systems can be provided wherein the teeth whitening moiety may have relatively low viscosity, due to the fluid uptaking and releasing properties of the nanofibrous structure. It is an advantage of embodiments according to the present invention that the risk of leaking out of the structure, e.g. on the Gingiva or the Palate in the mouth is limited, reduced or even avoided. Alternatively not a gel but an aqueous solution can be used and immobilized in the nanofibrous structure. Additionally, a low viscosity results in higher mobility of the bleaching compound in the gel, thus release of bleaching agent to the teeth is more efficient.

The teeth whitening system may comprise a Gingiva or Palate protecting component, such as for example a chemical component for protecting the Gingiva or Palate protecting component like GANTREZ®, the present invention not being limited thereto.

According to an embodiment of the present invention, the teeth whitening system may be a kit adapted to keep the nanofibrous structure and the teeth bleaching moiety separate during storage before use. When the pH regulating agent is provided in the nanofibrous structure, or at least separate from the teeth bleaching agent, the latter results in the possibility to operate the bleaching at an optimised pH resulting in a high efficiency of the bleaching agent. The teeth whitening system may be packed in a blister which itself may be used as a soaking tray for soaking the nanofibrous structure in the teeth whitening moiety. The device thus may be delivered to the user in two parts wherein the nanofibrous structure containing the pH regulator is one part and the moiety is another part.

In still another aspect, the present invention relates to a method for performing teeth bleaching. The method according to embodiments of the present invention may comprise using both a nanofibrous structure and a teeth whitening moiety for performing the teeth bleaching. The method may be applied in any suitable place, e.g. at the consumer's choice, i.e. not being limited to the dental practice but for example also at home. The method has the advantage that it provides bleaching of teeth, which results in an aesthetic effect. The method may be performed using a teeth bleaching system as described in any of the embodiments according to the first aspect of the present invention, although the invention is not limited thereto. The teeth whitening moiety may be packed together with the nanofibrous structure in one overall package but the teeth whitening moiety advantageously is not in direct contact with the nanofibrous structure during storage. The nanofibrous structure and/or the teeth whitening moiety may be packed in the container in which the teeth whitening moiety is to be poured. Such a package may be sealed with a plastic or cardboard film. The teeth whitening moiety may be present in an initial container which may be sealed. The method may comprise before said soaking the nanofibrous structure, providing the teeth whitening moiety in a container adapted for soaking the nanofibrous structure therein.

The method according to embodiments of the present invention, comprises soaking a nanofibrous structure in a teeth whitening moiety. For soaking the nanofibrous structure, the nanofibrous structure may be positioned in the container with the nanofibrous structure facing the moiety. The method furthermore may comprise providing initial contact between said pH regulating agent and said bleaching agent, during said soaking the nanofibrous structure.

According to embodiments of the present invention, the method also comprises applying the soaked nanofibrous structure to the teeth for a predetermined time and removing the nanofibrous structure thereafter. Applying the soaked nanofibrous structure may comprise adapting the shape of the nanofibrous structure to the shape of the teeth. By using a nanofibrous structure, the shape of the structure can be appropriately adapted to the shape of the teeth. The nanofibrous structure may have a structure so that fixation to the teeth is obtained through adhesive properties of the structure, e.g. due to the surface area of the fibres of the nanofibrous structure that can be in contact with the teeth. Applying the nanofibrous structure may comprise pressing the nanofibrous structure around the teeth. Applying the soaked nanofibrous structure may comprise applying the nanofibrous structure to the incisor teeth and the adjacent canine teeth so as to cover the tips of the canine teeth. The latter has the advantage that a homogeneous bleaching is obtained, whereby a plurality of teeth can be bleached, such as for example both the incisor teeth and the canine teeth at the same time. In some embodiments according to the present invention, the nanofibrous structure may be adapted for, upon applying the soaked nanofibrous structure, releasing teeth whitening moiety in a controlled way, e.g. at a controlled flow rate, to the teeth. The latter may for example be obtained by using a nanofibrous structure with a varying diameter, porosity or density of the fibres used. The methods according to embodiments of the present invention furthermore may comprise one or more steps expressing the functionality of one or more components of the teeth whitening system as described in the first aspect.

By way of illustration, the present invention not being limited thereto, an exemplary method according to an embodiment of the present invention is described below. A method for whitening teeth thereby is illustrated, the method making use of a teeth whitening system as described in the first aspect. The teeth whitening system thereby comprises a nanofibrous structure, in the present example being deposited on a substrate, and a teeth whitening moiety, in the present example being a teeth whitening gel in a plastic or glass container. The amount of teeth whitening gel thereby is between 1 to 2 ml. In the present example, the two components are stored in a plastic blister which is sealed with a plastic or cardboard film.

According to the exemplary method, the blister may be opened and the nanofibrous structure and the teeth whitening moiety may be removed from the blister. The plastic or glass container then may be opened and the teeth whitening moiety may be poured in the blister, which may operate as a tray. The nanofibrous structure, in the present example being deposited on a substrate, is then positioned in the blister. The latter advantageously is performed by providing the nanofibrous structure towards the teeth whitening moiety, while maintaining the substrate, if present directing away from the teeth whitening moiety. The teeth whitening moiety may thus be soaked by the nanofibrous structure. This process is completed in 2-5 minutes. During soaking of the teeth whitening moiety, preferably an initial contact between the teeth bleaching agent and the pH regulating agent is obtained as the pH regulating agent may be initially present in the nanofibrous structure or may be separately stored from the teeth bleaching moiety and provided to the nanofibrous structure before initiating the soaking. During the soaking, the teeth bleaching agent thus also may mix with the pH regulating compound which may result in increase of the pH to about 7-9. The soaked nanofibrous structure then may be taken out of the blister and the system then may be positioned onto the front teeth by a slight pressure. This positioning may include covering the incisor teeth as well as the canine teeth, including their tips. Positioning may comprise folding parts, e.g. triangular parts, over the teeth and fixing them onto the backside of the teeth. This fixing may be performed by providing the slight pressure, whereby the adhesive effect is obtained by the structure of the nanofibrous structure, without the need for adding an adhesive. The nanofibrous structure deposited on a substrate is maintained at the teeth for a predetermined time. After treatment, the nanofibrous structure deposited on a substrate may be removed by hand and the teeth may be rinsed with water or brushed.

In further aspects, the present invention also relates to the use of a teeth whitening system or a nanofibrous structure according to any of the embodiments of the aspects described above in a teeth whitening application. The advantages and features of the systems and/or structures described thereby may result in advantageous use of such systems and/or structures.

By way of illustration, embodiments of the present invention not being limited thereto, a number of examples of the first particular embodiments is shown below.

### Example 15

The device comprises (1) a nanofibrous structure deposited on a substrate, having dimensions of 7 by 2 cm, (2) a teeth whitening gel (1 mL) or solution filled in a plastic or glass container and a plastic blister containing (1) and (2) and sealed with a plastic or cardboard film. The blister is opened and components 1 and 2 are taken out. The plastic or glass container is opened and the gel is poured into the blister. The nanofibrous structure deposited on a substrate is positioned in the blister with the nanofibrous structure towards the gel (downward). The gel is soaked by the nanofibrous structure. This process is completed in 2-5 minutes. During soaking of the gel or solution, it also mixes with the pH regulating compound, present in the nanofibrous structure, which results in increase of the pH to about 8. The nanofibrous structure deposited on a substrate is taken out of the blister and the full part is positioned onto the front teeth by a slight pressure. The triangular parts are then folded over the teeth and fixed onto the backside of the teeth as these are inherently adhesive due to the nanofibrous structure. The nanofibrous structure deposited on a substrate and containing the gel is maintained at the teeth for a period of 10 minutes. After treatment the nanofibrous structure deposited on a substrate is removed by hand and the teeth are rinsed with water and/or brushed. This process is repeated twice a day for example for seven days.

The device as described above was used by 4 test persons according to the procedure described above. All test persons started with a teeth colour corresponding to A₃ on the VITA® shade scale. After 7 days of treatment the VITA shade of all teeth improved to A₁ shade, which is visually much more white than A₃. After 6 months the A₁ value is still maintained.

### Example 16

A teeth whitening gel that may be used in embodiments according to the present invention, and e.g. in the above described example 15 may be a gel for teeth whitening containing sorbitol 26; glycerol 25, hydrogen peroxide (35% solution) 20; Carboxymethylcellulose 0.10; Gantrez® 2.50; citric acid 0.04; sodium citrate 0.5, spear/peppermint 0.10 and water to obtain 100 m/m %. This composition results in a hydrogen peroxide concentration of 6%. The gel thus may be used with a device and according to a procedure as described in examples and/or embodiments of aspects of the present invention.

### Example 17

A teeth whitening gel that may be used in embodiments according to the present invention, and e.g. in the above described example 15 may be a gel for teeth whitening containing sorbitol 21; glycerol 20, hydrogen peroxide (35% solution) 40; Carboxymethylcellulose 0.10; Gantrez® 3.50; citric acid 0.04; sodium citrate 0.5, spear/peppermint 0.10 and water to obtain 100 m/m %. This composition results in a hydrogen peroxide concentration of 12%. The gel thus may be used with a device and according to a procedure as described in examples and/or embodiments of aspects of the present invention.

### Example 18

A teeth whitening gel that may be used in embodiments according to the present invention, and e.g. in the above described example 15 may be a gel for teeth whitening containing sorbitol 21; glycerol 20, hydrogen peroxide (35% solution) 50; Carboxymethylcellulose 0.10; Gantrez® 3.50; citric acid 0.04; sodium citrate 0.5, spear/peppermint 0.10 and water to obtain 100 m/m %. This composition results in a hydrogen peroxide concentration of 15%. The gel thus may be used with a device and according to a procedure as described in examples and/or embodiments of aspects of the present invention.

### Example 19

A teeth whitening gel that may be used in embodiments according to the present invention, and e.g. in the above described example 15 may be a gel for teeth whitening containing sorbitol 14.5; glycerol 13.9, hydrogen peroxide (35% solution) 66.7; Carboxymethylcellulose 0.10; Gantrez® 2.50; citric acid 0.04; sodium citrate 0.5, spear/peppermint 0.10 and water to obtain 100 m/m %. This composition results in a hydrogen peroxide concentration of 20%. The gel thus may be used with a device and according to a procedure as described in examples and/or embodiments of aspects of the present invention.

### Example 20

A teeth whitening gel that may be used in embodiments according to the present invention, and e.g. in the above described example 15 may be a gel for teeth whitening containing sorbitol 6; glycerol 6, hydrogen peroxide (35% solution) 83.3; Carboxymethylcellulose 0.10; Gantrez® 2.50; citric acid 0.04; sodium citrate 0.5, spear/peppermint 0.10 and water to obtain 100 m/m %. This composition results in a hydrogen peroxide concentration of 25%. The gel thus may be used with a device and according to a procedure as described in examples and/or embodiments of aspects of the present invention.

### Example 21

The examples as described above in examples 15 to 20 may for example be used in combination with a nanofibrous structure comprising fibres made of polyimide, wherein the electrospinning is performed using a mixture of formic and acetic acid 50/50% as a solvent.

1-25. (canceled)

26. An electrospinning device for electrospinning fibrous structures, said electrospinning device comprising:
a set of outlets arranged to output solution or melt,
a receiving surface arranged to receive output from said set of outlets, wherein said receiving surface is adapted to move in a first direction parallel to said receiving surface, said movement causing the lengthwise production of said fibrous structures,
a voltage source arranged to generate a potential difference between said set of outlets and said receiving surface,
wherein said electrospinning device is configured so that during electrospinning a variation between outlets of the device and the receiving surface is variable according to a predetermined distance profile is present in order to produce a predetermined fibre thickness profile over the fibrous structure.

27. The electrospinning device according to claim 26, wherein said variable distance is obtained by providing a predetermined distance profile for the distance between the outlets and the receiving surface in a direction perpendicular to the receiving surface for different outlets along said first direction.

28. The electrospinning device according to claim 26, wherein the predetermined distance profile is a decreasing or increasing distance profile.

29. The electrospinning device according to claim 28, wherein said distance profile is monotonously decreasing or a monotonously increasing distance profile.

30. The electrospinning device according to claim 26, wherein said set of outlets comprises at least two subsets of outlets, wherein each subset comprises outlets equidistant to said receiving surface and wherein the distance between each subset and the receiving surface is settable according to said predetermined distance profile along said first direction.

31. The electrospinning device according to claim 26, wherein said set of outlets is arranged in a plane inclined at an angle relative to the receiving surface.

32. The electrospinning device according to claim 26, wherein at least two neighbouring outlets of said set of outlets are separated from one another by a distance of at least 1 cm.

33. The electrospinning device according to claim 26, wherein the distance between the outlets within each of said set of outlets is adapted for obtaining a fibrous structure comprising at least 50% of fibres substantially free of cross-links to neighboring fibres.

34. The electrospinning device according to claim 26, wherein said set of outlets is adapted to be movable reciprocally in a direction parallel to said receiving surface and perpendicular to said first direction.

35. The electrospinning device according to claim 26, comprising a control device arranged to vary the distance between the outlets and the receiving surface to vary the diameter of the produced fibres during said electrospinning of said fibrous structure.

36. A method for producing fibrous structures comprising the steps of:
providing a set of outlets for outputting solution or melt,
providing a receiving surface for receiving output from said set of outlets moving said receiving surface in a first direction parallel to said receiving surface,
applying a potential difference between said set of outlets and said receiving surface,
during said moving and applying, providing a solution or melt to said outlets,
varying the distance between the outlets and the receiving surface according to a predetermined profile during the providing of the solution or melt to the outlets to obtain a predetermined fibre thickness profile.

37. The method according to claim 36, wherein said variation in the distance is obtained by providing a predetermined distance profile for the distance between the outlets and the receiving surface in a direction perpendicular to the receiving surface for different outlets along said first direction.

38. The method according to claim 36, wherein said variation in the distance is obtained by providing a relative movement of the outlets with respect to the receiving surface in a direction perpendicular to the receiving surface.

39. An electrospun fibrous structure comprising fibres having diameters, wherein the diameter of said fibres varies according to a predetermined profile along a dimension of said electrospun fibrous structure and wherein the variance of the fibres diameter in any section perpendicular to said dimension is below 10%, the variation of the diameter of the fibres according to a predetermined profile resulting from a variation according to a predetermined profile of the distance between outlets providing a solution or melt for generating the fibres and a receiving surface of the fibres, the variation in distance being provided during electrospinning.

40. The electrospun fibrous structure according to claim 39, the structure comprising at least 50% of straight fibres, wherein at least 50% of straight fibres consists of 50% or more fibres having segments substantially straight over a distance of 5 μm.

41. The electrospun fibrous structure according to claim 39, comprising at least 50% of fibres that are substantially cross-link free with respect to neighboring fibres.

42. The electrospun fibrous structure according to claim 39, wherein 50% or more of its fibres have an average diameter between 3 and 2000 nm.

43. The electrospun fibrous structure according to claim 39, said fibrous structure comprising two or more adjacent layers, each layer having two neighboring layers comprises fibres having an average diameter smaller than the average diameter of the fibres of one of its neighboring layer and larger than the average diameter of the fibres of its other neighboring layer.

44. A controller adapted for controlling variation of a predetermined distance profile for the distance between outlets and a receiving surface in an electrospinning device according to claim 26,

45. Use of an electrospun fibrous structure according to claim 39 for teeth bleaching.
